(19) United States
(12) Patent Application Publication
(10) Pub. No.: US 2025/0200692 A1
(43) Pub. Date: Jun. 19, 2025

(54) ACCELERATED DATA DECOMPRESSION USING PARALLEL PROCESSORS

(71) Applicant: NVIDIA Corporation, Santa Clara, CA (US)

(72) Inventors: Eric Schmidt, Fort Collins, CO (US); Nikolay Sakharnykh, Port Washington, NY (US); Adam Hendrickson, Morgan Hill, CA (US)

(21) Appl. No.: 18/544,166

(22) Filed: Dec. 18, 2023

(51) Int. Cl. G06T 1/20; G06T 9/00

(52) U.S. Cl. CPC G06T 1/20; G06T 9/00

(57) ABSTRACT

In various examples, a GPU may be equipped with specialized or dedicated hardware (e.g., a copy engine) customized for sliding window dictionary-based (e.g., Snappy) decompression. As such, data that was compressed using some unsupported compression format (e.g., Zstandard) may be transcoded to a supported compression format (e.g., Snappy) and decompressed in the supported format. In some embodiments, one or more entropy decoding operations (e.g., Huffman decoding, ANS decoding) and/or transcoding into a supported compression format (e.g., Snappy) may be executed on general-purpose hardware on a GPU (e.g., a SM) using GPU-accelerated computing (e.g., CUDA) software, and decompression may be executed on the GPU on specialized or dedicated hardware (e.g., a copy engine) customized for decompressing the supported compression format. In some embodiments, similar computations common to Huffman, extra bit, ANS, and/or other types of decoding operations may be parallelized (e.g., on a streaming multiprocessor of a GPU).

### BACKGROUND

Data compression and decompression are used in a variety of computing applications, such as those that seek to optimize data storage, transmission, and/or processing techniques. Compression typically seeks to identify and replace patterns or redundancies within blocks of data with more compact representations. During decompression, this process is reversed, reconstructing the original data from its compressed form. For example, in scenarios where large datasets need to be loaded onto a processor such as a graphics processing unit (GPU), compressing the data before transfer can significantly reduce the amount of memory bandwidth and storage space required. In applications where large volumes of data need to be transferred between processors (e.g., from a central processing unit (CPU) to a GPU), compression can help improve performance by reducing the amount of data that needs to be transferred. To use the data, a processor (e.g., a GPU) may need to decompress compressed data so the processor can work with the data in its uncompressed state. For example, in some scenarios involving graphics rendering or deep learning, the data may need to be in its uncompressed form to be processed effectively. In another example, if the data is stored in compressed form and retrieved from storage or received over a network transmission, the data might need to be decompressed before it can be utilized. Overall, data compression and decompression techniques often play a crucial role in improving the performance and efficiency of various computational tasks.

There are various types of compression formats. For example, Lempel-Ziv (LZ)-based compression techniques such as LZ4 and Zstandard (zSTD) prioritize achieving high compression ratios. LZ4 provides relatively high-speed compression and decompression and is known for striking a balance between efficiency and speed. Zstandard provides a wider range of compression levels, allowing users to select between faster compression or higher compression ratios based on needs of the application. Generally, each format has its own strengths and trade-offs, making different compression formats suitable for different applications.

Conventional data compression and decompression techniques have a variety of drawbacks. For example, decompression on a GPU is conventionally implemented purely in GPU-accelerated computing software (e.g., Compute Unified Device Architecture (CUDA) software) using general-purpose hardware (e.g., a streaming multiprocessor (SM)). Decompressing a number of compression formats requires the use of compute-intensive but highly-parallelizable entropy decoding operations before (e.g., LZ) decompression. For example, Zstandard decompression involves asymmetric numeral system (ANS) decoding and Huffman literal decoding, followed by LZ decompression. However, executing the LZ decompression phase on general-purpose hardware on a GPU (e.g., a SM) becomes a significant bottleneck because it involves a large number of small, unaligned, and dependent reads and writes. Usually, engineers and programmers who want to execute code on a GPU want to achieve parallelism at a thread group-level, which involves arranging computations so multiple threads within a group. Groups of threads may be referred to as warps or wavefronts. A warp is a fundamental unit of execution in a streaming multiprocessor of some GPUs, typically consisting of 32 threads that execute instructions in a SIMT (single instruction, multiple threads) fashion, which can execute the same instruction simultaneously. However, it is difficult to extract parallelism at a thread group-level when executing (e.g., entropy) decoding operations and the (e.g., LZ) decompression phase. As a result, conventional decompression techniques have not been able to use the available memory read/write throughput of the GPU efficiently. Furthermore, some existing CPUs include dedicated hardware that limits their compression and decompression compatibility to LZ-based formats, but LZ is incompatible with some other compression formats. For example, LZ4 cannot encode offsets longer than 64 kilobytes (KB), so CPUs with dedicated hardware that can only decompress LZ4 are incompatible with formats such as zSTD and LZMA that use longer offsets. As a result, data that was compressed using an incompatible compression format such as these cannot be processed using dedicated LZ hardware. For these and other reasons, there is a need for improved data decompression techniques.

### SUMMARY

Embodiments of the present disclosure relate to accelerated data decompression. For example, systems and methods are disclosed that transcode compressed data into a sliding window dictionary-based compression format, and decompress on specialized, dedicated, or fixed-function hardware customized for decompressing that compression format.

In contrast to conventional systems, such as those described above, a GPU or other parallel processor may be equipped with specialized, dedicated, or fixed-function hardware (e.g., a copy engine) customized for sliding window dictionary-based (e.g., Snappy) decompression. As such, data that was compressed using some unsupported compression format (e.g., Zstandard) may be transcoded to a supported compression format (e.g., Snappy) and decompressed in the supported format. In some embodiments, one or more entropy decoding (e.g., Huffman decoding, ANS decoding) operations and/or transcoding into a supported compression format (e.g., Snappy) may be executed on general-purpose hardware on a GPU (e.g., a SM) using GPU-accelerated computing (e.g., CUDA) software, and decompression may be executed on the GPU on specialized, dedicated, or fixed-function hardware (e.g., a copy engine or direct memory access engine) customized for decompressing the supported compression format. In some embodiments, similar computations across Huffman, ANS, and/or other types of entropy and other decoding operations may be parallelized (e.g., on a SM of a GPU). As such, the present techniques may be used to accelerate data decompression and free up computational resources in various applications, such those involved in querying compressed data, loading and decompressing large datasets, transferring data between processors, and/or other applications.

### BRIEF DESCRIPTION OF THE DRAWINGS

The present systems and methods for accelerated data decompression are described in detail below with reference to the attached drawing figures, wherein:

FIG. 1 is a block diagram of an example data decompression pipeline, in accordance with some embodiments of the present disclosure;

FIG. 2 is a block diagram of an example kernel for decoding compressed data using parallel processing, in accordance with some embodiments of the present disclosure;

FIG. 3 is a flow diagram illustrating a method of data decompression on a GPU, in accordance with some embodiments of the present disclosure;

FIG. 4 illustrates a parallel processing unit, in accordance with some embodiments of the present disclosure;

FIG. 5A illustrates a general processing cluster within the parallel processing unit of FIG. 4, in accordance with some embodiments of the present disclosure;

FIG. 5B illustrates a memory partition unit of the parallel processing unit of FIG. 4, in accordance with some embodiments of the present disclosure;

FIG. 6A illustrates the streaming multi-processor of FIG. 5A, in accordance with some embodiments of the present disclosure;

FIG. 6B is a conceptual diagram of a processing system implemented using the PPU of FIG. 4, in accordance with some embodiments of the present disclosure;

FIG. 6C illustrates an example system in which the processing system of FIG. 6B may be implemented, in accordance with some embodiments of the present disclosure;

FIG. 7 is a conceptual diagram of a graphics processing pipeline implemented by the parallel processing unit of FIG. 4, in accordance with some embodiments of the present disclosure; and

FIG. 8 is a block diagram of an example data center suitable for use in implementing some embodiments of the present disclosure.

### DETAILED DESCRIPTION

Systems and methods are disclosed relating to accelerated data decompression. For example, a GPU may be equipped with specialized, dedicated, or fixed-function hardware (e.g., a copy engine) customized for executing sliding window dictionary-based (e.g., Snappy) decompression. As such, data that was compressed using some unsupported compression format (e.g., Zstandard) may be transcoded to a supported compression format (e.g., Snappy) and decompressed in the supported format. In some embodiments, one or more entropy decoding operations (e.g., Huffman decoding, ANS decoding) and/or transcoding into a supported compression format (e.g., Snappy) may be executed on general-purpose hardware on a GPU (e.g., a SM) using GPU-accelerated computing (e.g., CUDA) software, and decompression may be executed on the GPU on specialized, dedicated, or fixed-function hardware (e.g., a copy engine) customized for decompressing the supported compression format. Decompressing transcoded data on specialized, dedicated, or fixed-function hardware facilitates decompression of unsupported compression formats at much higher speeds than would otherwise be possible using general-purpose hardware (e.g., CUDA implementations on the SM), and results in significant savings in time and computational resources compared to completing the entire decompression operation on general-purpose hardware (e.g., a CPU or a general-purpose processing unit of a GPU such as a SM).

In some embodiments, a GPU may be equipped with specialized, dedicated, or fixed-function hardware customized for decompressing one or more sliding window dictionary-based compression formats, such that decompression may be accelerated by executing it on the specialized, dedicated, or fixed-function hardware. Decompressing dictionary-based compression formats such as LZ4, Zstandard, Deflate, GDeflate, Snappy, and LZO typically operate by referencing a dictionary or history of patterns or sequences encountered during compression. For example, compressed data may comprise a series of encoded symbols that represent individual characters or references to previously encountered sequences in the data. A decoder may read each symbol sequentially, outputting a literal character when a symbol represents a literal character. When a symbol indicates a reference, the decoder may look back into a dictionary or history using a sliding or static window. For example, a dictionary may contain a sliding window or fixed-size buffer of recently encountered data, allowing the decoder to copy the corresponding sequence to the output.

In some embodiments, the specialized, dedicated, or fixed-function hardware may be customized for decompressing a sliding window dictionary-based compression format that has certain characteristics, such as one that does not rely on entropy encoding or decoding. For example, Snappy is a compression technique that is known for its speed and provides an LZ decompression phase with no entropy encoding or decoding. Additionally or alternatively, the specialized, dedicated, or fixed-function hardware may be customized for decompressing a sliding window dictionary-based compression format that supports offsets (which indicate the position of a matching sequence in relation to a current position in the stream) that are at least as long as the largest offset used by a compression format that will be transcoded. For example, Snappy provides a large-token mode which supports offsets up to 4 gigabytes (GB). In some embodiments, the specialized, dedicated, or fixed-function hardware is customized for decompressing a sliding window dictionary-based compression format that encodes literals and/or match tokens with predictable sizes. For example, with Snappy compression, literal lengths of up to 4 GB may be encoded with a single token, and short match copies (less than 64 bytes) may be encoded using 4-byte tokens. Matches longer than 64 bytes (which are rare) may be represented as sequences of 64-byte matches. Characteristics such as these may indicate a good fit for a transcode target for anticipated compression formats.

In some embodiments, data that was compressed using one compression format that relies on one or more entropy encoding operations may be decoded, transcoded to a supported compression format, and decompressed from the supported compression format. For example, one or more the entropy decoding operations (e.g., Huffman decoding, decoding ANS) may be performed on general-purpose hardware on a GPU (e.g., a SM) using GPU-accelerated computing (e.g., CUDA) software. Entropy decoding may be considered a good fit for general-purpose hardware (e.g., the SM) because it is compute-heavy and highly parallelizable. In some embodiments, the output of the entropy phase(s) may be transcoded into a supported sliding window dictionary-based compression format (e.g., Snappy), the decompression of which may be natively supported by specialized, dedicated, or fixed-function hardware, such as a copy engine of a GPU. For example, transcoding Zstandard to Snappy and decompressing in Snappy on dedicated hardware should result in a substantial increase in end-to-end throughput and should free up substantial computational (e.g., SM) resources for other tasks. Note that in embodiments in which (e.g., SM) entropy decoding and (e.g., copy engine) decompression both operate on memory that is local to a particular processor (e.g., GPU), this end-to-end operation need not involve any off-device memory transfers, further facilitating improved performance.

Generally, some compression formats were heavily optimized for the CPU and have many serial dependencies. That is, some compression formats were designed to make efficient use of CPU resources and take advantage of the CPU's capabilities for sequential processing, and therefore rely on a sequential execution flow where certain calculations or tasks must be completed in a specific order. As a result, some parts of the compression and decompression process for certain compression formats like Zstandard are inherently serial and cannot be easily parallelized. However, in some embodiments, parallelism may nevertheless be achieved in various ways.

For example, one or more (e.g., entropy) decoding operations may be parallelized for execution using a GPU by cooperatively decoding or otherwise processing independent data streams using corresponding threads (e.g., within a warp) to simultaneously execute a common set of shared (e.g., SIMT) instructions on each data stream. For example, any number of warps executing on any number of processing units (e.g., SMs) may cooperatively decode many independent compressed streams simultaneously. Generally, this technique may be used to decode data that was compressed using any compression format, including those that may not naturally support much parallelism in their entropy decoding operations (e.g., zSTD, LZMA, Deflate, etc.).

For example, a particular block, buffer, or other section of compressed data that encodes literals may be decomposed into some number of data streams that may be independently decoded. For example, each zSTD literal block may be decomposed into four independent streams of compressed data that may each be independently decoded to produce the same number of literals (or substantially the same when the total number of literals is not evenly divisible by the number of streams). As such, each of the streams may be assigned to a corresponding thread in a warp and decoded in parallel using a common set of shared instructions. Since a warp may be able to process more threads than the number of independent streams from a single block, buffer, or other section of compressed literals (e.g., a single zSTD literal block), streams from multiple blocks, buffers, or other sections of compressed literals (e.g., multiple zSTD literal blocks) may be assigned to some or all of the remaining threads in the warp. Continuing with the zSTD example and an example warp that can process up to 32 threads concurrently, eight zSTD literal blocks may be used to generate 32 independent streams, and the 32 streams may be assigned to 32 threads in a single warp and decoded simultaneously using a common set of shared instructions.

Additionally or alternatively, similar computations occurring across extra bit, ANS, and/or other types of decoding or other operations may be parallelized. For example, decoding of extra bits for match length, literal length, and offset may be decomposed into three corresponding independent read operations, and ANS decoding of symbols derived from literal length, match length, and offset tokens may be decomposed into three corresponding independent read operations. Taking the decoding of zSTD which includes both extra bit and ANS decoding as an example, within a single iteration, six independent reads may occur. Reads at the next iteration, the computation of pointers that should be read from, and other operations are typically dependent on the result of the current iteration. As such, each independent read may be assigned to a corresponding thread in a warp (e.g., six threads per zSTD block).

Accordingly, a particular block, buffer, or other section of compressed data that encodes literals and/or dictionary references may be decomposed into some number of data streams (e.g., six for each zSTD block) that may each include at least a portion that may be processed in parallel using a common set of shared (e.g., SIMT) instructions. For example, although some of the operations involved in decoding the different streams may be different, there may nevertheless be some similar computations that can be parallelized using shared instructions. For example, certain implementations of extra bit decoding and/or ANS decoding may include some similar operations such as loading data into an array and performing some addition using a result. As such, these similar operations may be executed by corresponding threads (e.g., in a warp) in parallel. In some embodiments, further parallelism may be achieved by decoding multiple blocks, buffers, or other sections of compressed data that encodes literals and/or dictionary references simultaneously. Continuing with the zSTD example and an example warp that can process up to 32 threads concurrently, five zSTD blocks may be used to generate 30 independent streams, and the 30 streams may be assigned to 30 threads (e.g., in a single warp) and decoded simultaneously using a common set of shared instructions.

As such, data may be decompressed by parallelizing similar computations across multiple decoding operations (e.g., on a SM of a GPU), transcoding into a sliding window dictionary-based compression format, and decompressing on specialized, dedicated, or fixed-function hardware (e.g., a copy engine) customized for that compression format. The present techniques may be used to accelerate data decompression and free up computational resources in various applications, such those involved in querying compressed data, loading and decompressing large datasets, transferring data between processors, and/or other applications.

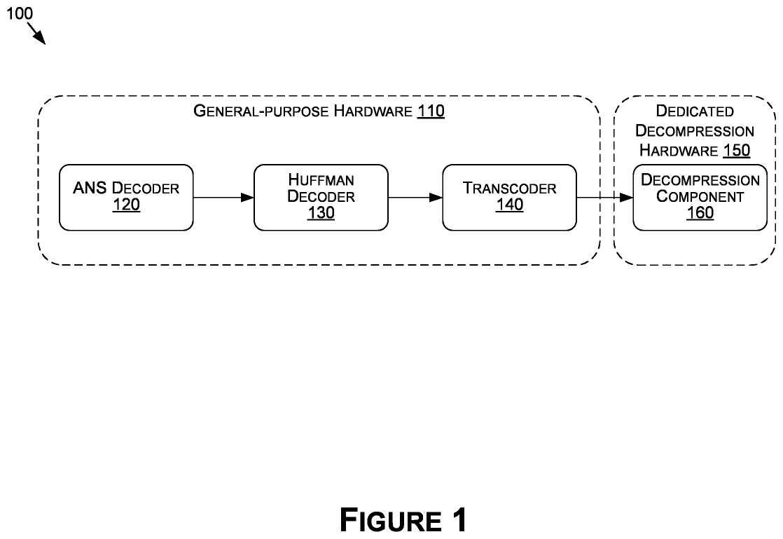

With reference to FIG. 1, FIG. 1 is an example data decompression pipeline 100, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory.

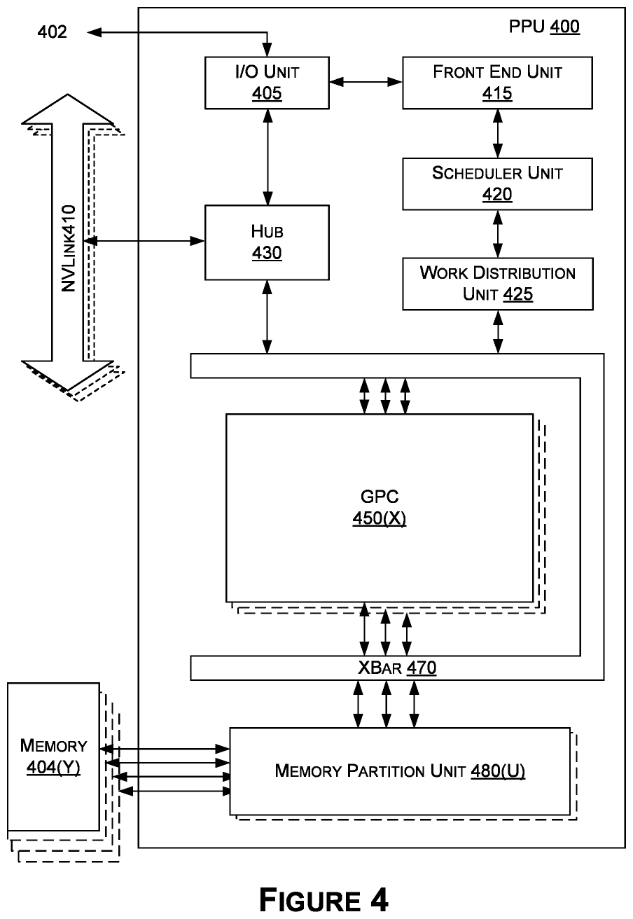

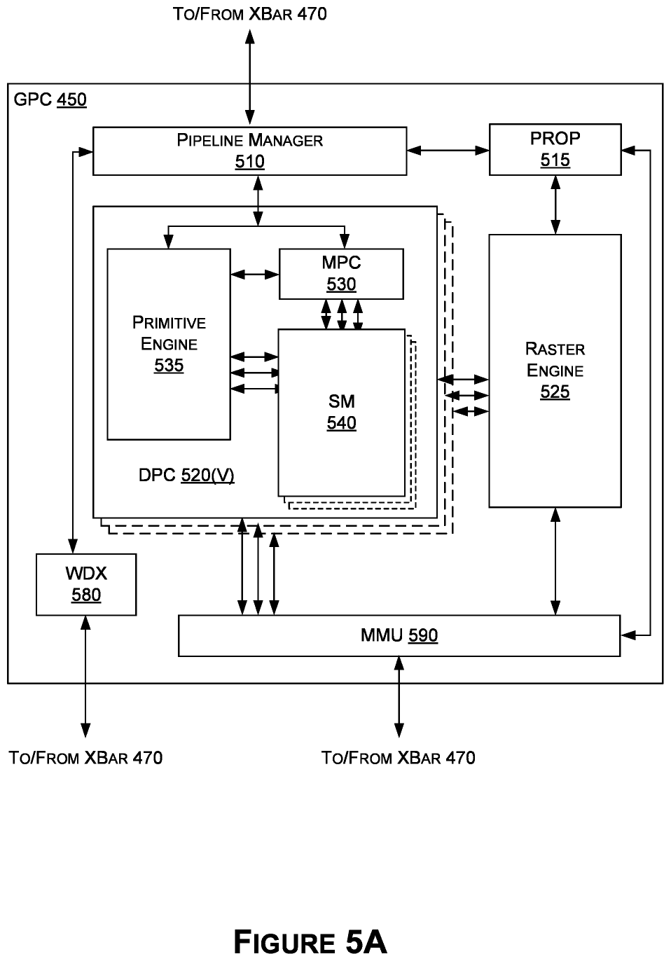

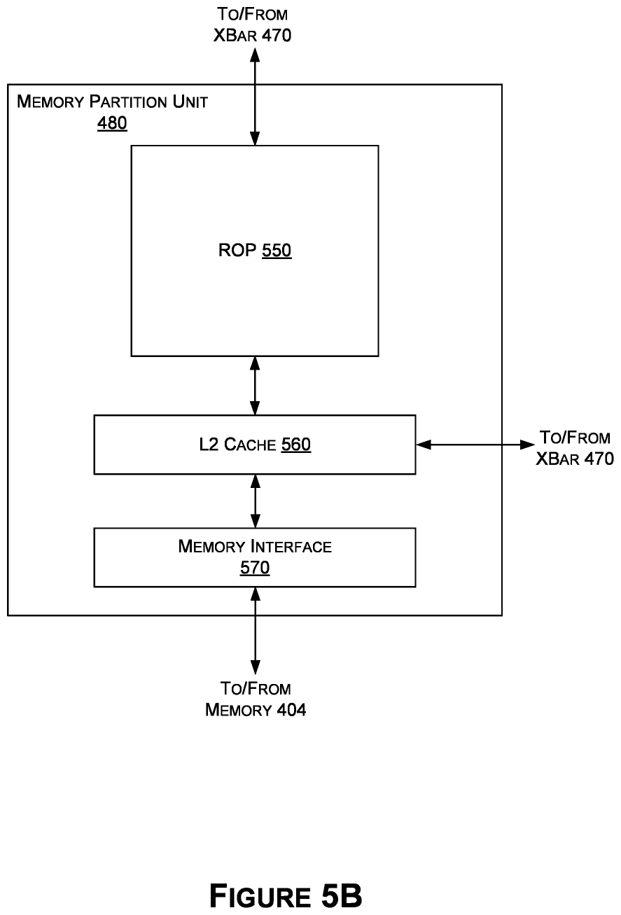

In FIG. 1, the data decompression pipeline 100 includes general-purpose hardware 110 and dedicated decompression hardware 150. As a general matter, general-purpose hardware is typically designed to perform a wide range of tasks or computations and can handle various types of workloads and applications, whereas dedicated hardware is specifically designed to optimize a particular task or a set of related tasks, often sacrificing versatility for increased performance and efficiency in that specialized area. In some embodiments, the data decompression pipeline 100 may be implemented at least in part on a parallel processing unit (e.g., the PPU 400 of FIG. 4) such as a GPU. For example, the general-purpose hardware 110 may correspond to a general-purpose processing unit (e.g., an SM such as the SM 540 of FIG. 5A) of the parallel processing unit, and the dedicated decompression hardware 150 may correspond to some other unit of the parallel processing unit, such as a copy engine, video encoder, video decoder, power management unit, and/or other units.

For example, a GPU copy engine, also known as a DMA (Direct Memory Access) engine, may be implemented as a dedicated hardware component that is responsible for efficiently transferring data between different regions of memory. It may serve as a dedicated data mover, facilitating high-speed, parallelized transfers of data between various storage locations, such as between system (or host) memory and GPU (or device) memory, or between different regions within GPU memory itself. As such, a copy engine may serve to offload the task of data movement from the GPU's main processing cores, freeing them up to focus on computational tasks. The copy engine may operate independently and perform memory transfers in parallel with other GPU operations, significantly enhancing overall system performance, particularly in scenarios where large datasets are loaded onto the GPU for processing, or where results need to be transferred back to system memory. As such, the GPU copy engine may be optimized for rapid and efficient data transfer, making it useful in efficiently executing applications such as those that require intensive data processing, such as scientific simulations, deep learning, and graphics rendering.

In some embodiments, a copy engine (or video encoder, video decoder, power management unit, specialized, dedicated, or fixed-function hardware unit, etc. of a parallel processing unit) may be implemented using the dedicated decompression hardware 150, and the dedicated decompression hardware 150 may be customized for sliding window dictionary-based (e.g., Snappy) decompression. As such, data that was compressed using some unsupported compression format (e.g., Zstandard) may be transcoded to a supported compression format (e.g., Snappy) by the general-purpose hardware 110 and decompressed from the compression format supported by the dedicated decompression hardware 150. Decompressing transcoded data on the dedicated decompression hardware 150 facilitates decompression of unsupported compression formats at much higher speeds, and results in significant savings in time and computational resources compared to decompressing on the general-purpose hardware 110 (e.g., on the SM 540 of FIG. 5A). And by implementing this functionality to decompress data in a unit such as a copy engine of a GPU, the efficiency gains provided by the copy engine are enhanced.

In some embodiments, the general-purpose hardware 110 (e.g., the SM 540 of FIG. 5A) may execute one or more entropy decoding operations and/or transcoding into a compression format supported by the dedicated decompression hardware 150. Generally, entropy decoding seeks to reverse entropy encoding, which represents data in a more compact form by assigning shorter codes to more frequently occurring symbols. Entropy decoding interprets these compressed codes and reconstructs the original symbols. Some example types of entropy decoding include Huffman decoding, ANS decoding, Golomb decoding, arithmetic decoding, Run-Length Decoding (RLD), and Fixed-Length decoding.

Generally, the applicable entropy decoding operations should depend on the compression format. For example, Zstandard uses both ANS and Huffman encoding in its compression phase, so the general-purpose hardware 110 may be used to perform ANS and Huffman decoding. As such, FIG. 1 illustrates an embodiment in which the data decompression pipeline 100 transcodes Zstandard by executing an ANS decoder 120, a Huffman decoder 130, and a transcoder 140 on the general-purpose hardware 110. In another example, GDeflate only has Huffman encoding in its compression phase, so to decompress GDeflate, a corresponding Huffman decoder and transcoder may be run on the general-purpose hardware 110 to transcode from GDeflate to the compression format supported by the dedicated decompression hardware 150. These are just a few examples, and the corresponding decoding operations for other compression formats will be understood by those of ordinary skill in the art.

Taking compressed data that was compressed using Zstandard as an example, the compressed data may be read and processed in blocks or chunks, where each block may encode a mix of literals (directly represented uncompressed bytes) and dictionary references (representing sequences). The ANS decoder 120 may be used to decode literals and dictionary references. For example, the ANS decoder 120 may maintain a cumulative distribution function (CDF) that provides probabilities of encountering different symbols, read encoded symbols (e.g., representing literals, or match lengths and offset values) from the compressed data, and use the CDF to map the encoded symbols back to their original (e.g., byte, or match length and offset) values, thereby reconstructing corresponding literals and dictionary references. The Huffman decoder 130 may be used to decode literals. For example, the Huffman decoder 130 may construct a Huffman tree based on the frequencies of each literal value and use the tree to decode the literals, converting them back to their original uncompressed form. Depending on the compression format of the compressed data, the corresponding entropy decoding operation(s), and/or the implementation, the resulting decoded data may take various forms (e.g., binary data) and may represent a series of symbols (representing literal lengths, match lengths, and offsets) and control information.

In some embodiments, the transcoder 140 may transcode the decoded data into the compression format supported by the dedicated decompression hardware 150. For example, depending on the implementation and the anticipated compression formats sought to be decompressed, the transcoder 140 may transcode the decoded data into a sliding window dictionary-based compression format such as Snappy, LZ, Zstandard, Deflate, GDeflate, LZO, and/or others. Taking a scenario in which Zstandard is decoded and transcoded to Snappy, the ANS decoder 120 and the Huffman decoder 130 may be used to reverse the entropy encoding used by Zstandard. Instead of performing LZ decompression, the transcoder 140 may transcode the entropy decoded data to Snappy, and the decompression component 160 may decompress Snappy on the dedicated decompression hardware 150 (since transcoding and Snappy decompression is expected to be faster than LZ decompression). This is meant simply as an example, and other combinations of source and target compression formats for transcoding and decompression may be implemented within the scope of the present disclosure.

In some embodiments, decoding and/or transcoding (e.g., on the general-purpose hardware 110) are executed on the same parallel processing unit (e.g., GPU) that decompresses on the dedicated decompression hardware 150, but this need not be the case. Generally, decoding and/or transcoding may be performed on any suitable device, whether or not they are executed on the same parallel processing unit (e.g., GPU) that executes the decompression on the dedicated decompression hardware 150. For example, in some scenarios (e.g., if there is less than some designated number of buffers of compressed and/or decoded data be transcoded, if the GPU executing the data decompression pipeline 100 is busier than an associated CPU), one or more buffers of compressed and/or decoded data may be transferred (e.g., from the GPU executing the data decompression pipeline 100) to an associated CPU, and the CPU may decode and/or transcode the one or more buffers and transfer the resulting (e.g., Snappy) buffers to the GPU for decompression on the dedicated decompression hardware 150.

Whether the transcoder 140 or some other component populates, loads, or otherwise identifies a buffer of transcoded data (e.g., in Snappy format) in (e.g., device, GPU) memory, the transcoder 140 (or some other component, such as a kernel or other software running on the general-purpose hardware 110 or on a host processor) may trigger the decompression component 160 (e.g., of a copy engine) to execute on the dedicated decompression hardware 150 to decompress the transcoded data in the buffer. For example, the transcoder 140 may call into a kernel (or other software running on the general-purpose hardware 110 or host processor) that takes a batch of pointers to device buffers and triggers the decompression component 160 to decompress the transcoded data in the buffers identified by pointers. In some embodiments, the kernel may wait for some or all buffers to finish transcoding before triggering decompression of a batch of buffers at a time. As such, the decompression component 160 may decompress one or more buffers of transcoded data.

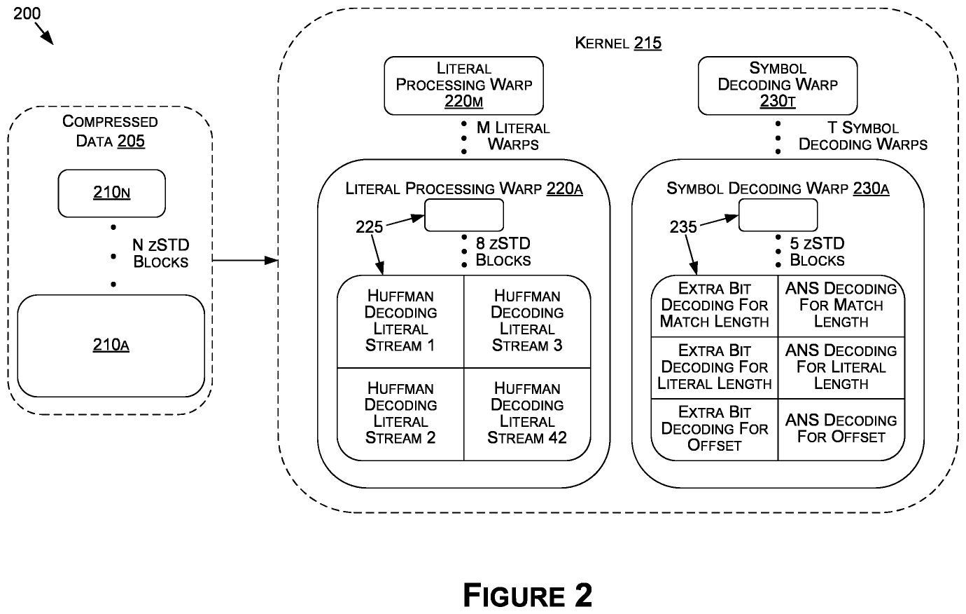

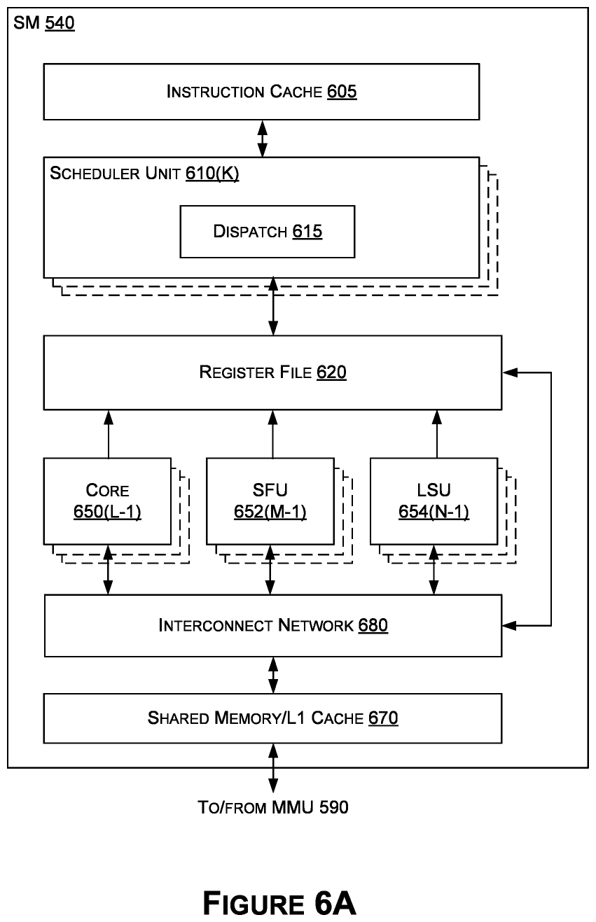

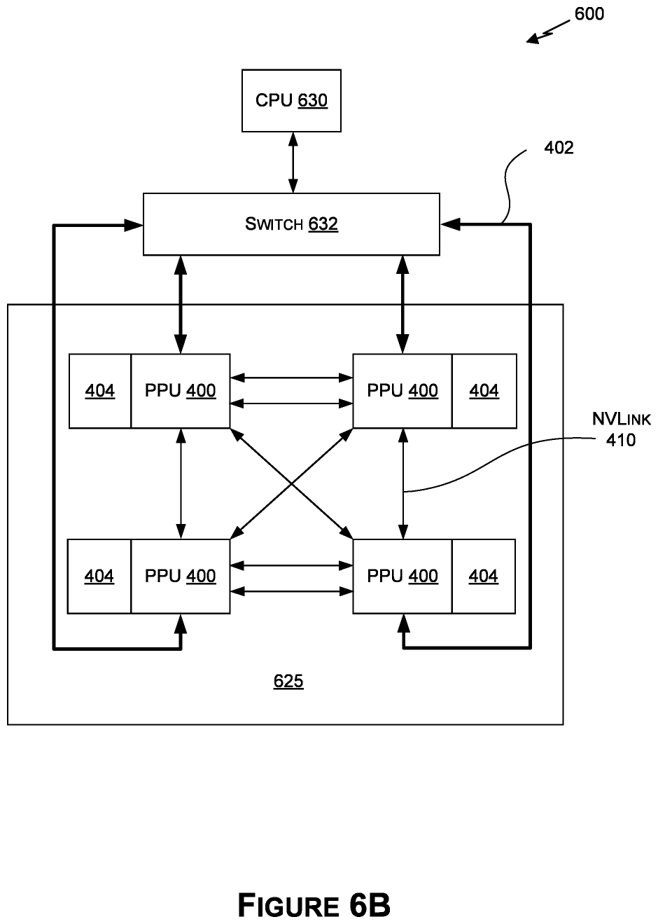

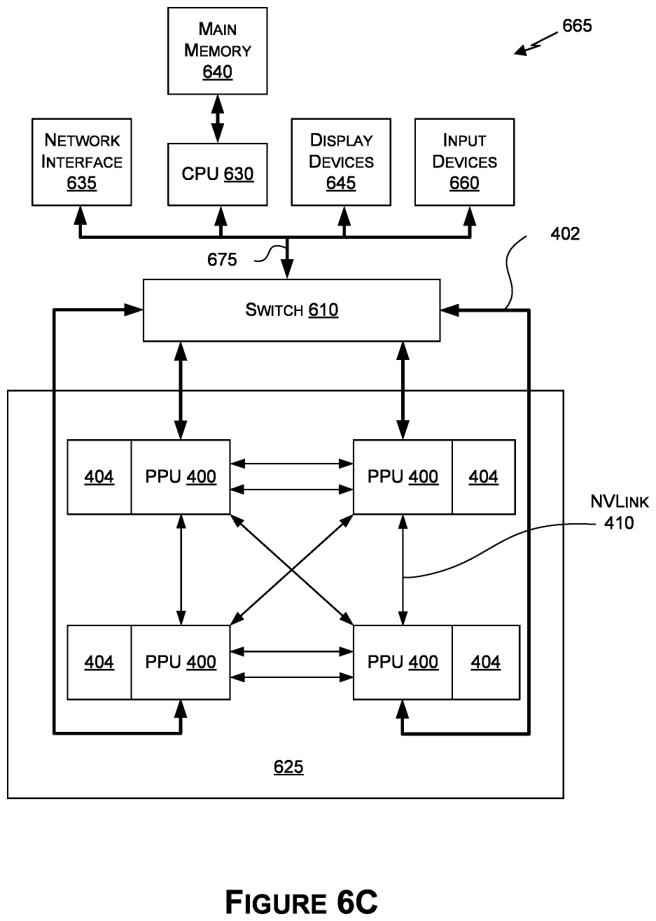

FIG. 2 is a block diagram of an example kernel 215 for decoding compressed data 205 using parallel processing, in accordance with some embodiments of the present disclosure. Generally, the kernel 215 may be responsible for managing the simultaneous execution of various threads on a GPU and/or coordinating their allocation across various processing cores (e.g., the cores 650 of FIG. 6A). In the example illustrated in FIG. 2, the kernel 215 coordinates the execution one or more groups of related threads (referred to herein as a warp) to decode one or more blocks of compressed data (e.g., on the general-purpose hardware 110 of FIG. 1, which may implement the SM 540 of FIG. 5A). Furthermore, FIG. 2 illustrates an example implementation involving entropy decoding of data that was compressed using ANS and Huffman decoding (e.g., using Zstandard), but this need not be the case, and entropy decoding for other compression formats (e.g., LZMA, Deflate, etc.) may be implemented within the scope of the present disclosure.

Note that in some embodiments, the kernel 215 may be implemented using (e.g., CUDA) software that runs on the general-purpose hardware 110 (e.g., on the SM 540 of FIG. 5A of a GPU), but this need not be the case. For example, in some embodiments, a computing system (such as the one described below with respect to FIG. 6B) may include both a GPU and a CPU (sometimes called a host processor) that work together in a computer system to handle different types of computational tasks. In some embodiments, the host processor may execute a driver kernel (such as the driver kernel described below with respect to FIG. 4), which is a software component that acts as an interface between the operating system and the hardware, including both the CPU and GPU. The driver kernel may operate at a lower level within the operating system, allowing it to directly communicate with and control the hardware components of the computer system, coordinate the utilization of system resources, and/or optimize interaction between software applications and the underlying hardware. The driver kernel may handle tasks such as memory management, process scheduling, and input/output operations. In the context of the GPU, the driver kernel may provide instructions and protocols for the operating system to use the GPU, for example, by initializing the GPU, allocating memory for GPU operations, managing the flow of data between the CPU and GPU, and/or providing an interface for software applications to offload certain computations to the GPU. As such, in some embodiments (not illustrated by FIG. 2), the kernel 215 may be implemented using (e.g., operating system) software that runs on the host processor.

In the Zstandard decoding example illustrated in FIG. 2, the compressed data 205 comprises N zSTD blocks (e.g., blocks 210a-n). Taking a single block 210a as an example, the block 210a of compressed data may include compressed data that encodes literals and/or dictionary references. In zSTD, these are often referred to as literal blocks and sequence streams. A literal block encodes literal values (single, uncompressed bytes or sequences of uncompressed bytes), whereas a sequence stream encodes dictionary references (also called matches) that represent repeated patterns found in the original data. The kernel 215 may allocate threads to a literal processing warp 220a to decode literals (e.g., using Huffman decoding for Zstandard), and/or the kernel 215 may allocate threads to a symbol decoding warp 230a to decode literals and/or dictionary references (e.g., using ANS and/or extra bit decoding).

For example, the kernel 215 (or some other component) may implement or trigger a decoder that sequentially reads tokens from the block 210a of compressed data. When the decoder encounters a literal token, the decoder may read the corresponding number of bytes from the block 210a of compressed data directly into an output buffer. This action effectively restores uncompressed data directly into the output. If the token indicates a match length, the decoder may interpret it as the length of a repeating sequence, retrieve this number of bytes from a previously decoded section of the output, and append it to the output buffer. When encountering an offset sequence token, the decoder may read the appropriate number of bits to extract an offset value, and use the offset to locate and copy the matching data from the output buffer.

Continuing with the Zstandard decoding example illustrated in FIG. 2, the kernel 215 may identify blocks that encode literals or dictionary references (or both). For example, the block header represents whether the block includes a literal block, a sequence stream, or both. As such, the kernel 215 may read the header of one or more of the blocks 210a-n to identify blocks that include literals, and for each such block (e.g., the block 210a), the kernel 215 may decompose the literal block into (e.g., four) independent streams of literals and assign each such literal stream to a corresponding thread in the literal processing warp 220a configured to perform Huffman decoding (or some other entropy decoding operation). Using an example warp that can process up to 32 threads concurrently, the kernel 215 may decompose eight zSTD literal blocks into 32 independent literal streams and assign the 32 streams to 32 threads (identified by reference number 225) in the literal processing warp 220a, which may decode the 32 independent literal streams simultaneously using a common set of shared instructions. In some embodiments, the kernel 215 may trigger and execute any number of literal processing warps 220a-m this way.

Additionally or alternatively, the kernel 215 may parallelize independent reads and/or similar computations common to extra bit, ANS, and/or other types of decoding of the blocks 210a-n compressed data. For example, extra bit decoding is a process used with variable-length codes like Huffman coding, where an additional bit is used to indicate whether a received code is complete or requires further decoding. Extra bits may be used in a zSTD literal block to encode additional information about the literal data, such as literal lengths or other characteristics of the uncompressed data. Extra bits may be used in sequence streams to provide additional information such as the length of sequences or offset values. For example, in match length tokens, extra bits may be used to specify lengths that exceed the range covered by a single token. In offset sequence tokens, extra bits may be used to fine-tune the offset value. In some embodiments, the kernel 215 may decompose decoding of the extra bits for match length, literal length, and/or offset into (e.g., three) corresponding independent read operations and assign each read to a corresponding thread in the symbol decoding warp 230a.

Additionally or alternatively, ANS decoding may be used to decode symbols that represent literals and/or dictionary references. In literal block decoding, encoded symbols representing literal lengths and literal values may be read from the block 210a, and an ANS decoder (e.g., the ANS decoder 120 of FIG. 1) may use them to reconstruct the original literal data. In sequence stream decoding, encoded symbols representing match lengths and offset values may be read from the blocks 210a, and the ANS decoder may interpret them to reconstruct the dictionary references. In some embodiments, the kernel 215 may decompose ANS decoding of symbols derived from literal length, match length, and/or offset tokens into (e.g., three) corresponding independent read operations and assign each read to a corresponding thread in the symbol decoding warp 230a.

There are some operations that may be common to certain implementations of decoding operations such as extra bit decoding and/or ANS decoding that may be parallelized. For example, certain implementations of extra bit decoding and/or ANS decoding may include similar computations such as loading data into an array and performing some addition using a result. In some such embodiments, the kernel 215 may assign these similar computations for extra bit decoding and/or ANS decoding to a corresponding thread in the symbol decoding warp 230a. The embodiment illustrated in FIG. 2 represents an example in which similar computations associated with the three independent reads for extra bit decoding and three independent reads for ANS decoding are assigned to the same symbol decoding warp 230a and executed simultaneously using a common set of shared instructions. Using an example warp that can process up to 32 threads concurrently, the kernel 215 may decompose five zSTD blocks into 30 independent reads and assign the 30 reads to 30 threads (identified by reference number 235) in the symbol decoding warps 230a. In some embodiments, the kernel 215 may trigger and execute any number of symbol decoding warps 230a-t this way.

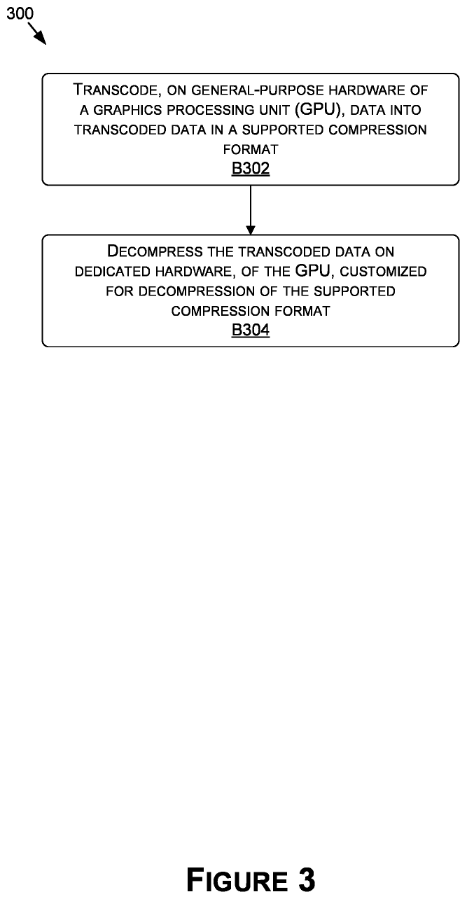

Now referring to FIG. 3, each block of method 300, described herein, comprises a computing process that may be performed using any combination of hardware, firmware, and/or software. For instance, various functions may be carried out by a processor executing instructions stored in memory. The method 300 may also be embodied as computer-usable instructions stored on computer storage media. The method 300 may be provided by a standalone application, a service or hosted service (standalone or in combination with another hosted service), or a plug-in to another product, to name a few. In addition, method 300 is described, by way of example, with respect to the data decompression pipeline 100 of FIG. 1. However, this method may additionally or alternatively be executed by any one system, or any combination of systems, including, but not limited to, those described herein.

FIG. 3 is a flow diagram showing a method 300 of data decompression on a GPU, in accordance with some embodiments of the present disclosure. The method 300, at block B302, includes transcoding, on general-purpose hardware of a graphics processing unit (GPU), data into transcoded data in a supported compression format. For example, with respect to the data decompression pipeline 100 of FIG. 1, the transcoder 140 may transcode the data which was decoded by the ANS decoder 120 and the Huffman decoder 130 into the compression format supported by the dedicated decompression hardware 150. Depending on the implementation and the anticipated compression formats sought to be decompressed, the transcoder 140 may transcode the data which was decoded by the ANS decoder 120 and the Huffman decoder 130 into a sliding window dictionary-based compression format such as Snappy, LZ, Zstandard, Deflate, GDeflate, LZO, and/or others.

The method 300, at block B304, includes decompressing the transcoded data on dedicated hardware of the GPU customized for decompression of the supported compression format. For example, with respect to the data decompression pipeline 100 of FIG. 1, the transcoder 140 (or some other component, such as a kernel or other software running on the general-purpose hardware 110 or on a host processor) may trigger the decompression component 160 (e.g., of a copy engine) to execute on the dedicated decompression hardware 150 to decompress the transcoded data in the buffer. For example, the transcoder 140 may call into a kernel (or other software running on the general-purpose hardware 110 or host processor) that takes a batch of pointers to device buffers and triggers the decompression component 160 to decompress the transcoded data in the buffers identified by pointers. In some embodiments, the kernel may wait for some or all buffers to finish transcoding before triggering decompression of a batch of buffers at a time. As such, the decompression component 160 may decompress one or more buffers of transcoded data.

The systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, data center processing, conversational AI, light transport simulation (e.g., ray-tracing, path tracing, etc.), collaborative content creation for 3D assets, cloud computing and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medial systems, boating systems, smart area monitoring systems, systems for performing deep learning operations, systems for performing simulation operations, systems for performing digital twin operations, systems implemented using an edge device, systems incorporating one or more virtual machines (VMs), systems for performing synthetic data generation operations, systems implemented at least partially in a data center, systems for performing conversational AI operations, systems implementing one or more language models-such as one or more large language models (LLMs), systems for performing light transport simulation, systems for performing collaborative content creation for 3D assets, systems implemented at least partially using cloud computing resources, and/or other types of systems.

### Parallel Processing Architecture

FIG. 4 illustrates a parallel processing unit (PPU) 400, in accordance with an embodiment. In an embodiment, the PPU 400 is a multi-threaded processor that is implemented on one or more integrated circuit devices. The PPU 400 is a latency hiding architecture designed to process many threads in parallel. A thread (e.g., a thread of execution) is an instantiation of a set of instructions configured to be executed by the PPU 400. In an embodiment, the PPU 400 is a graphics processing unit (GPU) configured to implement a graphics rendering pipeline for processing three-dimensional (3D) graphics data in order to generate two-dimensional (2D) image data for display on a display device such as a liquid crystal display (LCD) device. Additionally or alternatively, the PPU 400 may be utilized for general-purpose computations. While certain embodiments focus on features of the example parallel processing unit described herein, this is meant simply as an example, and other processors may be implemented within the scope of the present disclosure.

One or more instances of the PPU 400 may be configured to accelerate thousands of High Performance Computing (HPC), data center, and/or machine learning applications. The PPU 400 may be configured to accelerate numerous deep learning systems and/or other applications, such as autonomous vehicle platforms, deep learning, high-accuracy speech, image, and text recognition systems, intelligent video analytics, molecular simulations, drug discovery, disease diagnosis, weather forecasting, big data analytics, astronomy, molecular dynamics simulation, financial modeling, robotics, factory automation, real-time language translation, online search optimizations, and personalized user recommendations, to name a few examples.

As shown in FIG. 4, the PPU 400 includes an Input/Output (I/O) unit 405, a front end unit 415, a scheduler unit 420, a work distribution unit 425, a hub 430, a crossbar (Xbar) 470, one or more general processing clusters (GPCs) 450, and one or more partition units 480. The PPU 400 may be connected to a host processor or other PPUs 400 via one or more high-speed NVLink 410 interconnect. The PPU 400 may be connected to a host processor or other peripheral devices via an interconnect 402. The PPU 400 may also be connected to a local memory comprising any number of memory devices (e.g., memory 404). In an embodiment, the local memory may comprise a number of dynamic random access memory (DRAM) devices. The DRAM devices may be configured as a high-bandwidth memory (HBM) subsystem, with multiple DRAM dies stacked within each device.

The NVLink 410 interconnect enables systems to scale and include one or more PPUs 400 combined with one or more CPUs, supports cache coherence between the PPUs 400 and CPUs, and CPU mastering. Data and/or commands may be transmitted by the NVLink 410 through the hub 430 to/from other units of the PPU 400 such as one or more copy engines, a video encoder, a video decoder, a power management unit, etc. (not explicitly shown). The NVLink 410 is described in more detail in conjunction with FIG. 6B.

The I/O unit 405 is configured to transmit and receive communications (e.g., commands, data, etc.) from a host processor (not shown) over the interconnect 402. The I/O unit 405 may communicate with the host processor directly via the interconnect 402 and/or through one or more intermediate devices such as a memory bridge. In an embodiment, the I/O unit 405 may communicate with one or more other processors such as one or more PPUs 400 via the interconnect 402. In an embodiment, the I/O unit 405 implements a Peripheral Component Interconnect Express (PCIe) interface for communications over a PCIe bus and the interconnect 402 is a PCIe bus. In alternative embodiments, the I/O unit 405 may implement other types of well-known interfaces for communicating with external devices.

The I/O unit 405 decodes packets received via the interconnect 402. In an embodiment, the packets represent commands configured to cause the PPU 400 to perform various operations. The I/O unit 405 transmits the decoded commands to various other units of the PPU 400 as the commands may specify. For example, some commands may be transmitted to the front end unit 415. Other commands may additionally or alternatively be transmitted to the hub 430 or other units of the PPU 400 such as one or more copy engines, a video encoder, a video decoder, a power management unit, etc. (not explicitly shown). In other words, the I/O unit 405 may route communications between and among the various logical units of the PPU 400.

In an embodiment, a program executed by the host processor may encode a command stream in a buffer that provides workloads to the PPU 400 for processing. A workload may comprise several instructions and data to be processed by those instructions. The buffer is a region in a memory that is accessible (e.g., read/write) by both the host processor and the PPU 400. For example, the I/O unit 405 may be configured to access the buffer in a system memory connected to the interconnect 402 via memory requests transmitted over the interconnect 402. In an embodiment, the host processor writes the command stream to the buffer and then transmits a pointer to the start of the command stream to the PPU 400. The front end unit 415 may receive pointers to one or more command streams. As such, the front end unit 415 may manage the one or more streams, reading commands from the streams and forwarding commands to the various units of the PPU 400.

The front end unit 415 may be coupled to a scheduler unit 420 that configures the various GPCs 450 to process tasks defined by the one or more streams. The scheduler unit 420 is configured to track state information related to the various tasks managed by the scheduler unit 420. The state may indicate which GPC 450 a task is assigned to, whether the task is active or inactive, a priority level associated with the task, and so forth. The scheduler unit 420 manages the execution of a plurality of tasks on the one or more GPCs 450.

Continuing with the embodiment illustrated in FIG. 4, the scheduler unit 420 may be coupled to a work distribution unit 425 that is configured to dispatch tasks for execution on the GPCs 450. The work distribution unit 425 may track a number of scheduled tasks received from the scheduler unit 420. In an embodiment, the work distribution unit 425 manages a pending task pool and an active task pool for each of the GPCs 450. The pending task pool may comprise a number of slots (e.g., 32 slots) that contain tasks assigned to be processed by a particular GPC 450. The active task pool may comprise a number of slots (e.g., 4 slots) for tasks that are actively being processed by the GPCs 450. As a GPC 450 finishes the execution of a task, that task may be evicted from the active task pool for the GPC 450 and one of the other tasks from the pending task pool may be selected and scheduled for execution on the GPC 450. If an active task has been idle on the GPC 450, such as while waiting for a data dependency to be resolved, then the active task may be evicted from the GPC 450 and returned to the pending task pool while another task in the pending task pool is selected and scheduled for execution on the GPC 450.

The work distribution unit 425 may communicate with the one or more GPCs 450 via XBar 470. The XBar 470 may comprise an interconnect network that couples many of the units of the PPU 400 to other units of the PPU 400. For example, the XBar 470 may be configured to couple the work distribution unit 425 to a particular GPC 450. Although not shown explicitly, one or more other units of the PPU 400 may also be connected to the XBar 470 via the hub 430.

The tasks may be managed by the scheduler unit 420 and dispatched to a GPC 450 by the work distribution unit 425. The GPC 450 may be configured to process the tasks and generate results. The results may be consumed by other tasks within the GPC 450, routed to a different GPC 450 via the XBar 470, or stored in the memory 404. The results may be written to the memory 404 via the partition units 480, which may implement a memory interface for reading and writing data to/from the memory 404. The results may be transmitted to another PPU 400 or CPU via the NVLink 410. In an embodiment, the PPU 400 includes a number U of partition units 480 that is equal to the number of separate and distinct memory 404 devices coupled to the PPU 400. A partition unit 480 will be described in more detail in conjunction with FIG. 5B.

In an embodiment, a host processor executes a driver kernel that implements an application programming interface (API) that enables one or more applications executing on the host processor to schedule operations for execution on the PPU 400. In an embodiment, multiple compute applications are simultaneously executed by the PPU 400 and the PPU 400 provides isolation, quality of service (QOS), and independent address spaces for the multiple compute applications. An application may generate instructions (e.g., API calls) that cause the driver kernel to generate one or more tasks for execution by the PPU 400. The driver kernel may output tasks to one or more streams being processed by the PPU 400. Each task may comprise one or more groups of related threads, referred to herein as a warp. In an embodiment, a warp comprises 32 related threads that may be executed in parallel. Cooperating threads may refer to a plurality of threads including instructions to perform the task and that may exchange data through shared memory. Threads and cooperating threads are described in more detail in conjunction with FIG. 6A.

FIG. 5A illustrates a GPC 450 of the PPU 400 of FIG. 4, in accordance with an embodiment. As shown in FIG. 5A, each GPC 450 includes a number of hardware units for processing tasks. In an embodiment, each GPC 450 includes a pipeline manager 510, a pre-raster operations unit (PROP) 515, a raster engine 525, a work distribution crossbar (WDX) 580, a memory management unit (MMU) 590, and one or more Data Processing Clusters (DPCs) 520. It will be appreciated that the GPC 450 of FIG. 5A may include other hardware units in lieu of or in addition to the units shown in FIG. 5A.

In an embodiment, the operation of the GPC 450 is controlled by the pipeline manager 510. The pipeline manager 510 manages the configuration of the one or more DPCs 520 for processing tasks allocated to the GPC 450. In an embodiment, the pipeline manager 510 may configure at least one of the one or more DPCs 520 to implement at least a portion of a graphics rendering pipeline. For example, a DPC 520 may be configured to execute a vertex shader program on the programmable streaming multiprocessor (SM) 540. The pipeline manager 510 may also be configured to route packets received from the work distribution unit 425 to the appropriate logical units within the GPC 450. For example, some packets may be routed to fixed function hardware units in the PROP 515 and/or raster engine 525 while other packets may be routed to the DPCs 520 for processing by the primitive engine 535 or the SM 540. In an embodiment, the pipeline manager 510 may configure at least one of the one or more DPCs 520 to implement a neural network model and/or a computing pipeline.

The PROP unit 515 may be configured to route data generated by the raster engine 525 and the DPCs 520 to a Raster Operations (ROP) unit, described in more detail in conjunction with FIG. 5B. In some embodiments, the PROP unit 515 is configured to perform optimizations for color blending, organize pixel data, perform address translations, and/or other tasks.

The raster engine 525 includes a number of fixed function hardware units configured to perform various raster operations. In an embodiment, the raster engine 525 includes a setup engine, a coarse raster engine, a culling engine, a clipping engine, a fine raster engine, and/or a tile coalescing engine. The setup engine may receive transformed vertices and generate plane equations associated with the geometric primitive defined by the vertices. The plane equations may be transmitted to the coarse raster engine to generate coverage information (e.g., an x, y coverage mask for a tile) for the primitive. The output of the coarse raster engine may be transmitted to the culling engine where fragments associated with the primitive that fail a z-test may be culled, and transmitted to a clipping engine where fragments lying outside a viewing frustum may be clipped. Those fragments that survive clipping and culling may be passed to the fine raster engine to generate attributes for the pixel fragments based on the plane equations generated by the setup engine. The output of the raster engine 525 may comprise fragments to be processed, for example, by a fragment shader implemented within a DPC 520.

Each DPC 520 included in the GPC 450 may include an M-Pipe Controller (MPC) 530, a primitive engine 535, and one or more SMs 540. The MPC 530 may control the operation of the DPC 520, routing packets received from the pipeline manager 510 to the appropriate units in the DPC 520. For example, packets associated with a vertex may be routed to the primitive engine 535, which may be configured to fetch vertex attributes associated with the vertex from the memory 404. In contrast, packets associated with a shader program may be transmitted to the SM 540.

The SM 540 comprises a programmable streaming processor that is configured to process tasks represented by a number of threads. Each SM 540 is multi-threaded and configured to execute a plurality of threads (e.g., 32 threads) from a particular group of threads concurrently. In an embodiment, the SM 540 implements a SIMD (Single-Instruction, Multiple-Data) architecture where each thread in a group of threads (e.g., a warp) is configured to process a different set of data based on the same set of instructions. All threads in the group of threads execute the same instructions. In another embodiment, the SM 540 implements a SIMT (Single-Instruction, Multiple Thread) architecture where each thread in a group of threads is configured to process a different set of data based on the same set of instructions, but where individual threads in the group of threads are allowed to diverge during execution. In an embodiment, a program counter, call stack, and execution state is maintained for each warp, enabling concurrency between warps and serial execution within warps when threads within the warp diverge. In another embodiment, a program counter, call stack, and execution state is maintained for each individual thread, enabling equal concurrency between all threads, within and between warps. When execution state is maintained for each individual thread, threads executing the same instructions may be converged and executed in parallel for maximum efficiency. The SM 540 will be described in more detail below in conjunction with FIG. 6A.

The MMU 590 provides an interface between the GPC 450 and the partition unit 480. The MMU 590 may provide translation of virtual addresses into physical addresses, memory protection, and arbitration of memory requests. In an embodiment, the MMU 590 provides one or more translation lookaside buffers (TLBs) for performing translation of virtual addresses into physical addresses in the memory 404.

FIG. 5B illustrates a memory partition unit 480 of the PPU 400 of FIG. 4, in accordance with an embodiment. As shown in FIG. 5B, the memory partition unit 480 includes a Raster Operations (ROP) unit 550, a level two (L2) cache 560, and a memory interface 570. The memory interface 570 is coupled to the memory 404. Memory interface 570 may implement 32, 64, 128, 1024-bit data buses, or other types of data buses, for high-speed data transfer. In an embodiment, the PPU 400 incorporates U memory interfaces 570, one memory interface 570 per pair of partition units 480, where each pair of partition units 480 is connected to a corresponding memory device (e.g., memory 404). For example, PPU 400 may be connected to up to Y memory devices, such as high bandwidth memory stacks or graphics double-data-rate, version 5, synchronous dynamic random access memory, or other types of persistent storage.

In an embodiment, the memory interface 570 implements an HBM2 memory interface and Y equals half U. In an embodiment, the HBM2 memory stacks are located on the same physical package as the PPU 400, providing substantial power and area savings compared with conventional GDDR5 SDRAM systems. In an embodiment, each HBM2 stack includes four memory dies and Y equals 4, with HBM2 stack including two 128-bit channels per die for a total of 8 channels and a data bus width of 1024 bits.

In an embodiment, the memory 404 supports Single-Error Correcting Double-Error Detecting (SECDED) Error Correction Code (ECC) to protect data. ECC provides higher reliability for compute applications that are sensitive to data corruption. Reliability is especially important in large-scale cluster computing environments where PPUs 400 process very large datasets and/or run applications for extended periods.

In an embodiment, the PPU 400 implements a multi-level memory hierarchy. In an embodiment, the memory partition unit 480 supports a unified memory to provide a single unified virtual address space for CPU and PPU 400 memory, enabling data sharing between virtual memory systems. In an embodiment, the frequency of accesses by a PPU 400 to memory located on other processors is traced to ensure that memory pages are moved to the physical memory of the PPU 400 that is accessing the pages more frequently. In an embodiment, the NVLink 410 supports address translation services allowing the PPU 400 to directly access a CPU's page tables and providing full access to CPU memory by the PPU 400.

In an embodiment, copy engines transfer data between multiple PPUs 400 or between PPUs 400 and CPUs. The copy engines may generate page faults for addresses that are not mapped into the page tables. The memory partition unit 480 may then service the page faults, mapping the addresses into the page table, after which the copy engine may perform the transfer. In a conventional system, memory may be pinned (e.g., non-pageable) for multiple copy engine operations between multiple processors, substantially reducing the available memory. With hardware page faulting, addresses may be passed to the copy engines independent of whether the memory pages are in use, and the copying process may occur seamlessly.

Data from the memory 404 or other system memory may be fetched by the memory partition unit 480 and stored in the L2 cache 560, which is located on-chip and is shared between the various GPCs 450. As shown, each memory partition unit 480 includes a portion of the L2 cache 560 associated with a corresponding memory device (e.g., memory 404). Lower level caches may be implemented in various units within the GPCs 450. For example, each of the SMs 540 may implement a level one (L1) cache. The L1 cache is private memory that is dedicated to a particular SM 540. Data from the L2 cache 560 may be fetched and stored in each of the L1 caches for processing in the functional units of the SMs 540. The L2 cache 560 is coupled to the memory interface 570 and the XBar 470.

The ROP unit 550 may perform graphics raster operations related to pixel color, such as color compression, pixel blending, and/or the like. The ROP unit 550 may implements depth testing in conjunction with the raster engine 525, receiving a depth for a sample location associated with a pixel fragment from the culling engine of the raster engine 525. The depth may be tested against a corresponding depth in a depth buffer for a sample location associated with the fragment. If the fragment passes the depth test for the sample location, the ROP unit 550 may update the depth buffer and transmit a result of the depth test to the raster engine 525. It will be appreciated that the number of partition units 480 may be different than the number of GPCs 450 and, therefore, each ROP unit 550 may be coupled to each of the GPCs 450. The ROP unit 550 may track packets received from the different GPCs 450 and determine to which GPC 450 a result generated by the ROP unit 550 is routed through the Xbar 470. Although the ROP unit 550 is included within the memory partition unit 480 in FIG. 5B, in some embodiments, the ROP unit 550 may be outside of the memory partition unit 480. For example, the ROP unit 550 may reside in the GPC 450 or another unit.

FIG. 6A illustrates the streaming multi-processor 540 of FIG. 5A, in accordance with an embodiment. As shown in FIG. 6A, the SM 540 includes an instruction cache 605, one or more scheduler units 610, a register file 620, one or more processing cores 650, one or more special function units (SFUs) 652, one or more load/store units (LSUs) 654, an interconnect network 680, a shared memory/L1 cache 670.

As described above, the work distribution unit 425 dispatches tasks for execution on the GPCs 450 of the PPU 400. The tasks are allocated to a particular DPC 520 within a GPC 450 and, if the task is associated with a shader program, the task may be allocated to an SM 540. The scheduler unit 610 may receive the tasks from the work distribution unit 425 and manage instruction scheduling for one or more thread blocks assigned to the SM 540. The scheduler unit 610 may schedule thread blocks for execution as warps of parallel threads, where each thread block may be allocated at least one warp. In an embodiment, each warp executes 32 threads. The scheduler unit 610 may manage a plurality of different thread blocks, allocating the warps to the different thread blocks and then dispatching instructions from the plurality of different cooperative groups to the various functional units (e.g., cores 650, SFUs 652, and LSUs 654) during each clock cycle.

Cooperative Groups is a programming model for organizing groups of communicating threads that allows developers to express the granularity at which threads are communicating, enabling the expression of richer, more efficient parallel decompositions. Cooperative launch APIs support synchronization amongst thread blocks for the execution of parallel algorithms. Conventional programming models provide a single, simple construct for synchronizing cooperating threads: a barrier across all threads of a thread block (e.g., the syncthreads( ) function). However, programmers would often like to define groups of threads at smaller than thread block granularities and synchronize within the defined groups to enable greater performance, design flexibility, and software reuse in the form of collective group-wide function interfaces.

Cooperative Groups enables programmers to define groups of threads explicitly at sub-block (e.g., as small as a single thread) and multi-block granularities, and to perform collective operations such as synchronization on the threads in a cooperative group. The programming model supports clean composition across software boundaries, so that libraries and utility functions can synchronize safely within their local context without having to make assumptions about convergence. Cooperative Groups primitives enable new patterns of cooperative parallelism, including producer-consumer parallelism, opportunistic parallelism, and global synchronization across an entire grid of thread blocks.

A dispatch unit 615 may be configured to transmit instructions to one or more of the functional units. In the embodiment, the scheduler unit 610 includes two dispatch units 615 that enable two different instructions from the same warp to be dispatched during each clock cycle. In alternative embodiments, each scheduler unit 610 may include a single dispatch unit 615 or additional dispatch units 615.

Each SM 540 may include a register file 620 that provides a set of registers for the functional units of the SM 540. In an embodiment, the register file 620 is divided between each of the functional units such that each functional unit is allocated a dedicated portion of the register file 620. In some embodiments, the register file 620 is divided between the different warps being executed by the SM 540. The register file 620 provides temporary storage for operands connected to the data paths of the functional units.

Each SM 540 may comprise L processing cores 650. In an embodiment, the SM 540 includes a large number (e.g., 128, etc.) of distinct processing cores 650. Each core 650 may include a fully-pipelined, single-precision, double-precision, and/or mixed precision processing unit that includes a floating point arithmetic logic unit and an integer arithmetic logic unit. In an embodiment, the floating point arithmetic logic units implement the IEEE 754-2008 standard for floating point arithmetic. In an embodiment, the cores 650 include 64 single-precision (32-bit) floating point cores, 64 integer cores, 32 double-precision (64-bit) floating point cores, and 8 tensor cores.

Tensor cores configured to perform matrix operations, and, in an embodiment, one or more tensor cores are included in the cores 650. In particular, the tensor cores may be configured to perform deep learning matrix arithmetic, such as convolution operations for neural network training and inferencing. In an embodiment, each tensor core operates on a 4×4 matrix and performs a matrix multiply and accumulate operation D=A×B+C, where A, B, C, and D are 4×4 matrices.

In an embodiment, the matrix multiply inputs A and B are 16-bit floating point matrices, while the accumulation matrices C and D may be 16-bit floating point or 32-bit floating point matrices. Tensor Cores may operate on 16-bit floating point input data with 32-bit floating point accumulation. The 16-bit floating point multiply requires 64 operations and results in a full precision product that is then accumulated using 32-bit floating point addition with the other intermediate products for a 4×4×4 matrix multiply. In practice, Tensor Cores are often used to perform much larger two-dimensional or higher dimensional matrix operations, built up from these smaller elements. An API, such as CUDA C++ API, may expose specialized matrix load, matrix multiply and accumulate, and/or matrix store operations to efficiently use Tensor Cores from a CUDA-C++ program. At the CUDA level, the warp-level interface may assumes 16×16 size matrices spanning all 32 threads of the warp.

Each SM 540 may comprise M SFUs 652 that perform special functions (e.g., attribute evaluation, reciprocal square root, and the like). In an embodiment, the SFUs 652 may include a tree traversal unit configured to traverse a hierarchical tree data structure. In an embodiment, the SFUs 652 may include texture unit configured to perform texture map filtering operations. In an embodiment, the texture units are configured to load texture maps (e.g., a 2D array of texels) from the memory 404 and sample the texture maps to produce sampled texture values for use in shader programs executed by the SM 540. In an embodiment, the texture maps are stored in the shared memory/L1 cache 670. The texture units may implement texture operations such as filtering operations using mip-maps (e.g., texture maps of varying levels of detail). In an embodiment, each SM 440 includes two texture units.

Each SM 540 may comprise N LSUs 654 that implement load and store operations between the shared memory/L1 cache 670 and the register file 620. Each SM 540 may include an interconnect network 680 that connects each of the functional units to the register file 620 and the LSU 654 to the register file 620, shared memory/L1 cache 670. In an embodiment, the interconnect network 680 is a crossbar that can be configured to connect any of the functional units to any of the registers in the register file 620 and connect the LSUs 654 to the register file and memory locations in shared memory/L1 cache 670.

The shared memory/L1 cache 670 may be an array of on-chip memory that allows for data storage and communication between the SM 540 and the primitive engine 535 and between threads in the SM 540. In an embodiment, the shared memory/L1 cache 670 comprises 128 KB of storage capacity and is in the path from the SM 540 to the partition unit 480. The shared memory/L1 cache 670 can be used to cache reads and writes. One or more of the shared memory/L1 cache 670, L2 cache 560, and memory 404 may be backing stores.

Combining data cache and shared memory functionality into a single memory block may provide the best overall performance for both types of memory accesses. The capacity may be usable as a cache by programs that do not use shared memory. For example, if shared memory is configured to use half of the capacity, texture and load/store operations may use the remaining capacity. Integration within the shared memory/L1 cache 670 may enable the shared memory/L1 cache 670 to function as a high-throughput conduit for streaming data while simultaneously providing high-bandwidth and low-latency access to frequently reused data.

When configured for general purpose parallel computation, a simpler configuration may be used compared with graphics processing. For example, the fixed function graphics processing units shown in FIG. 4 may be bypassed, creating a much simpler programming model. In such a general purpose parallel computation configuration, the work distribution unit 425 may assign and distribute blocks of threads directly to the DPCs 520. The threads in a block may execute the same program, using a unique thread ID in the calculation to ensure each thread generates unique results, using the SM 540 to execute the program and perform calculations, shared memory/L1 cache 670 to communicate between threads, and the LSU 654 to read and write global memory through the shared memory/L1 cache 670 and the memory partition unit 480. When configured for general purpose parallel computation, the SM 540 may write commands that the scheduler unit 420 can use to launch new work on the DPCs 520.

The PPU 400 may be included in a desktop computer, a laptop computer, a tablet computer, servers, supercomputers, a smart-phone (e.g., a wireless, hand-held device), personal digital assistant (PDA), a digital camera, a vehicle, a head mounted display, a hand-held electronic device, and/or other devices. In an embodiment, the PPU 400 is embodied on a single semiconductor substrate. In another embodiment, the PPU 400 is included in a system-on-a-chip (SoC) along with one or more other devices such as additional PPUs 400, the memory, a reduced instruction set computer (RISC) CPU, a memory management unit (MMU), a digital-to-analog converter (DAC), and/or others.

In an embodiment, the PPU 400 may be included on a graphics card that includes one or more memory devices (e.g., memory 404). The graphics card may be configured to interface with a PCIe slot on a motherboard of a desktop computer. In some embodiments, the PPU 400 may be an integrated graphics processing unit (iGPU) or parallel processor included in the chipset of the motherboard.

### Exemplary Computing System

Systems with multiple GPUs and CPUs are used in a variety of industries as developers expose and leverage more parallelism in applications such as artificial intelligence computing. High-performance GPU-accelerated systems with tens to many thousands of compute nodes may be deployed in data centers, research facilities, and/or supercomputers to solve ever larger problems. As the number of processing devices within the high-performance systems increases, the communication and data transfer mechanisms may need to scale to support the increased bandwidth.

FIG. 6B is a conceptual diagram of a processing system 600 implemented using the PPU 400 of FIG. 4, in accordance with an embodiment. The processing system 600 includes a CPU 630, switch 632, and multiple PPUs 400 each and respective memories 404. The NVLink 410 may provide high-speed communication links between each of the PPUs 400. Although a particular number of NVLink 410 and interconnect 402 connections are illustrated in FIG. 6B, the number of connections to each PPU 400 and the CPU 630 may vary. The switch 632 may interface between the interconnect 402 and the CPU 630. The PPUs 400, memories 404, and NVLinks 410 may be situated on a single semiconductor platform to form a parallel processing module 625. In an embodiment, the switch 632 supports two or more protocols to interface between various different connections and/or links.

In another embodiment (not shown), the NVLink 410 provides one or more high-speed communication links between each of the PPUs 400 and the CPU 630 and the switch 632 interfaces between the interconnect 402 and each of the PPUs 400. The PPUs 400, memories 404, and the interconnect 402 may be situated on a single semiconductor platform to form a parallel processing module 625. In some embodiments (not shown), the interconnect 402 provides one or more communication links between each of the PPUs 400 and the CPU 630, and the switch 632 interfaces between each of the PPUs 400 using the NVLink 410 to provide one or more high-speed communication links between the PPUs 400. In some embodiments (not shown), the NVLink 410 provides one or more high-speed communication links between the PPUs 400 and the CPU 630 through the switch 632. In some embodiments (not shown), the interconnect 402 provides one or more communication links between each of the PPUs 400 directly. One or more of the NVLink 410 high-speed communication links may be implemented as a physical NVLink interconnect or either an on-chip or on-die interconnect using the same protocol as the NVLink 410.

In the context of the present description, a single semiconductor platform may refer to a sole unitary semiconductor-based integrated circuit fabricated on a die or chip. It should be noted that the term single semiconductor platform may also refer to multi-chip modules with increased connectivity which simulate on-chip operation and make substantial improvements over utilizing a conventional bus implementation. Of course, the various circuits or devices may be situated separately or in various combinations of semiconductor platforms per the desires of the designer. In some embodiments, the parallel processing module 625 may be implemented as a circuit board substrate and each of the PPUs 400 and/or memories 404 may be packaged devices. In an embodiment, the CPU 630, switch 632, and the parallel processing module 625 are situated on a single semiconductor platform.

In an embodiment, the signaling rate of each NVLink 410 is 20 to 25 Gigabits/second and each PPU 400 includes six NVLink 410 interfaces (as shown in FIG. 6B, five NVLink 410 interfaces are included for each PPU 400). Each NVLink 410 may provide a particular data transfer rate (e.g., 25 Gigabytes/second) in each direction, with six links providing 400 Gigabytes/second. The NVLinks 410 may be used exclusively for PPU-to-PPU communication as shown in FIG. 6B, or some combination of PPU-to-PPU and PPU-to-CPU, when the CPU 630 also includes one or more NVLink 410 interfaces.

In an embodiment, the NVLink 410 allows direct load/store/atomic access from the CPU 630 to each PPU's 400 memory 404. In an embodiment, the NVLink 410 supports coherency operations, allowing data read from the memories 404 to be stored in the cache hierarchy of the CPU 630, reducing cache access latency for the CPU 630. In an embodiment, the NVLink 410 includes support for Address Translation Services (ATS), allowing the PPU 400 to directly access page tables within the CPU 630. One or more of the NVLinks 410 may be configured to operate in a low-power mode.

FIG. 6C illustrates an exemplary system 665 in which the processing system of FIG. 6B may be implemented, in accordance with some embodiments of the present disclosure. More specifically, FIG. 6C illustrates a system 665 comprising at least one central processing unit 630 that is connected to a communication bus 675. The communication bus 675 may be implemented using any suitable protocol, such as PCI (Peripheral Component Interconnect), PCI-Express, AGP (Accelerated Graphics Port), HyperTransport, or any other bus or point-to-point communication protocol(s). The system 665 includes a main memory 640. Control logic (software) and data may be stored in the main memory 640, which may take the form of random access memory (RAM).

Continuing with the example implementation illustrated in FIG. 6C, the system 665 includes input devices 660, the parallel processing system 625, and display devices 645, e.g. a conventional CRT (cathode ray tube), LCD (liquid crystal display), LED (light emitting diode), plasma display, and/or others. User input may be received from the input devices 660, e.g., keyboard, mouse, touchpad, microphone, etc. Each of the foregoing modules and/or devices may be situated on a single semiconductor platform to form the system 665. In some embodiments, the various modules may be situated separately or in various combinations of semiconductor platforms.

In some embodiments, the system 665 may be coupled to a network (e.g., a telecommunications network, local area network (LAN), wireless network, wide area network (WAN) such as the Internet, peer-to-peer network, cable network, etc.) through a network interface 635 for communication purposes.

The system 665 may include a secondary storage (not shown), which may include a hard disk drive and/or a removable storage drive, representing a floppy disk drive, a magnetic tape drive, a compact disk drive, digital versatile disk (DVD) drive, recording device, universal serial bus (USB) flash memory, and/or others. The removable storage drive may read from and/or write to a removable storage unit in a well-known manner.

Computer programs, or computer control logic algorithms, may be stored in the main memory 640 and/or the secondary storage. Such computer programs, when executed, enable the system 665 to perform various functions. The main memory 640, the storage, and/or any other storage are possible examples of computer-readable media.

The architecture and/or functionality of the various previous figures may be implemented in the context of a general computer system, a circuit board system, a game console system dedicated for entertainment purposes, an application-specific system, and/or any other desired system. For example, the system 665 may take the form of a desktop computer, a laptop computer, a tablet computer, servers, supercomputers, a smart-phone (e.g., a wireless, hand-held device), personal digital assistant (PDA), a digital camera, a vehicle, a head mounted display, a hand-held electronic device, a mobile phone device, a television, workstation, game consoles, embedded system, and/or any other device.

### Graphics Processing Pipeline

In an embodiment, the PPU 400 comprises a graphics processing unit (GPU). The PPU 400 may be configured to receive commands that specify shader programs for processing graphics data. Graphics data may be defined as a set of primitives such as points, lines, triangles, quads, triangle strips, and/or the like. Typically, a primitive includes data that specifies a number of vertices for the primitive (e.g., in a model-space coordinate system) as well as attributes associated with each vertex of the primitive. The PPU 400 may be configured to process the graphics primitives to generate a frame buffer (e.g., pixel data for each of the pixels of the display).

An application may write model data for a scene (e.g., a collection of vertices and attributes) to a memory such as a system memory or memory 404. The model data may define each of the objects that may be visible on a display. The application may then make an API call to the driver kernel that requests the model data to be rendered and displayed. The driver kernel may read the model data and write commands to the one or more streams to perform operations to process the model data. The commands may reference different shader programs to be implemented on the SMs 540 of the PPU 400 including one or more of a vertex shader, hull shader, domain shader, geometry shader, and a pixel shader. For example, one or more of the SMs 540 may be configured to execute a vertex shader program that processes a number of vertices defined by the model data. In an embodiment, the different SMs 540 may be configured to execute different shader programs concurrently. For example, a first subset of SMs 540 may be configured to execute a vertex shader program while a second subset of SMs 540 may be configured to execute a pixel shader program. The first subset of SMs 540 may process vertex data to produce processed vertex data and write the processed vertex data to the L2 cache 560 and/or the memory 404. After the processed vertex data is rasterized (e.g., transformed from three-dimensional data into two-dimensional data in screen space) to produce fragment data, the second subset of SMs 540 may execute a pixel shader to produce processed fragment data, which may then be blended with other processed fragment data and written to the frame buffer in memory 404. The vertex shader program and pixel shader program may execute concurrently, processing different data from the same scene in a pipelined fashion until all of the model data for the scene has been rendered to the frame buffer. Then, the contents of the frame buffer may be transmitted to a display controller for display on a display device.

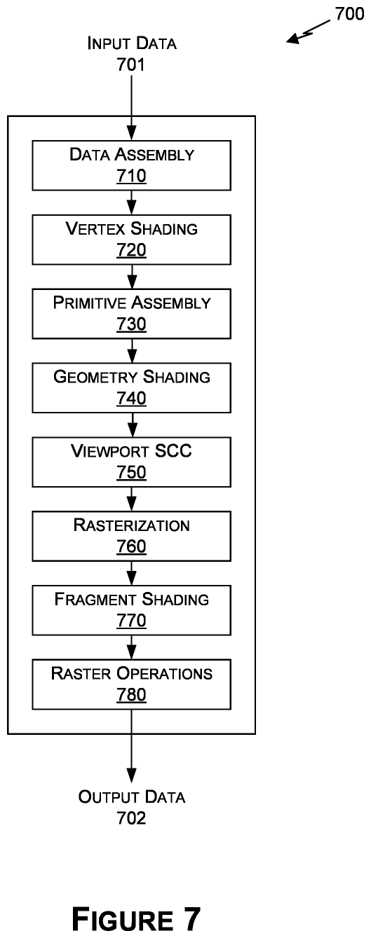

FIG. 7 is a conceptual diagram of a graphics processing pipeline 700 implemented by the PPU 400 of FIG. 4, in accordance with an embodiment. The graphics processing pipeline 700 is an abstract flow diagram of the processing steps implemented to generate 2D computer-generated images from 3D geometry data. As will be understood, pipeline architectures may perform long latency operations more efficiently by splitting up the operation into a plurality of stages, where the output of each stage is coupled to the input of the next successive stage. Thus, the graphics processing pipeline 700 may receive input data 701 that is transmitted from one stage to the next stage of the graphics processing pipeline 700 to generate output data 702. In an embodiment, the graphics processing pipeline 700 may represent a graphics processing pipeline defined by the OpenGL® API. In some embodiments, the graphics processing pipeline 700 may be implemented using the some or all of the functionality and architectures described herein.

As shown in FIG. 7, the graphics processing pipeline 700 comprises a pipeline architecture that includes a number of stages. The stages may include a data assembly stage 710, a vertex shading stage 720, a primitive assembly stage 730, a geometry shading stage 740, a viewport scale, cull, and clip (VSCC) stage 750, a rasterization stage 760, a fragment shading stage 770, and a raster operations stage 780. In an embodiment, the input data 701 comprises commands that configure the processing units to implement the stages of the graphics processing pipeline 700 and geometric primitives (e.g., points, lines, triangles, quads, triangle strips or fans, etc.) to be processed by the stages. The output data 702 may comprise pixel data (e.g., color data) that is copied into a frame buffer or other type of surface data structure in a memory.

The data assembly stage 710 may receive the input data 701 that specifies vertex data for high-order surfaces, primitives, or the like. The data assembly stage 710 may collect the vertex data in a temporary storage or queue, such as by receiving a command from the host processor that includes a pointer to a buffer in memory and reading the vertex data from the buffer. The vertex data may then be transmitted to the vertex shading stage 720 for processing.

The vertex shading stage 720 may process vertex data by performing a set of operations (e.g., a vertex shader or a program) once for each of the vertices. Vertices may be, e.g., specified as a 4-coordinate vector (e.g., <x, y, z, w>) associated with one or more vertex attributes (e.g., color, texture coordinates, surface normal, etc.). The vertex shading stage 720 may manipulate individual vertex attributes such as position, color, texture coordinates, and the like. In other words, the vertex shading stage 720 may perform operations on the vertex coordinates or other vertex attributes associated with a vertex. Such operations may include lighting operations (e.g., modifying color attributes for a vertex) and/or transformation operations (e.g., modifying the coordinate space for a vertex). For example, vertices may be specified using coordinates in an object-coordinate space, which may be transformed by multiplying the coordinates by a matrix that translates the coordinates from the object-coordinate space into a world space or a normalized-device-coordinate (NCD) space. The vertex shading stage 720 may generate transformed vertex data that is transmitted to the primitive assembly stage 730.

The primitive assembly stage 730 may collect vertices output by the vertex shading stage 720 and group the vertices into geometric primitives for processing by the geometry shading stage 740. For example, the primitive assembly stage 730 may be configured to group every three consecutive vertices as a geometric primitive (e.g., a triangle) for transmission to the geometry shading stage 740. In some embodiments, specific vertices may be reused for consecutive geometric primitives (e.g., two consecutive triangles in a triangle strip may share two vertices). The primitive assembly stage 730 may transmit geometric primitives (e.g., a collection of associated vertices) to the geometry shading stage 740.

The geometry shading stage 740 may processe geometric primitives by performing a set of operations (e.g., a geometry shader or program) on the geometric primitives. Tessellation operations may generate one or more geometric primitives from each geometric primitive. In other words, the geometry shading stage 740 may subdivide each geometric primitive into a finer mesh of two or more geometric primitives for processing by the rest of the graphics processing pipeline 700. The geometry shading stage 740 may transmit geometric primitives to the VSCC stage 750.

In an embodiment, the graphics processing pipeline 700 may operate within a streaming multiprocessor and the vertex shading stage 720, the primitive assembly stage 730, the geometry shading stage 740, the fragment shading stage 770, and/or hardware/software associated therewith, may sequentially perform processing operations. Once the sequential processing operations are complete, in an embodiment, the VSCC stage 750 may utilize the data. In an embodiment, primitive data processed by one or more of the stages in the graphics processing pipeline 700 may be written to a cache (e.g. L1 cache, a vertex cache, etc.). In this case, in an embodiment, the VSCC stage 750 may access the data in the cache. In an embodiment, the VSCC stage 750 and the rasterization stage 760 are implemented as fixed function circuitry.

The VSCC stage 750 may perform viewport scaling, culling, and clipping of the geometric primitives. Each surface being rendered may be associated with an abstract camera position representing a location of a viewer looking at the scene and defining a viewing frustum that encloses the objects of the scene. The viewing frustum may include a viewing plane, a rear plane, and four clipping planes. Any geometric primitive entirely outside of the viewing frustum may be culled (e.g., discarded) because the geometric primitive will not contribute to the final rendered scene. Any geometric primitive that is partially inside the viewing frustum and partially outside the viewing frustum may be clipped (e.g., transformed into a new geometric primitive that is enclosed within the viewing frustum). Furthermore, geometric primitives may each be scaled based on a depth of the viewing frustum. All potentially visible geometric primitives may be transmitted to the rasterization stage 760.

The rasterization stage 760 may convert the 3D geometric primitives into 2D fragments (e.g. capable of being utilized for display, etc.). The rasterization stage 760 may be configured to utilize the vertices of the geometric primitives to setup a set of plane equations from which various attributes can be interpolated. The rasterization stage 760 may compute a coverage mask for a plurality of pixels that indicates whether one or more sample locations for the pixel intercept the geometric primitive. In an embodiment, z-testing may be performed to determine if the geometric primitive is occluded by other geometric primitives that have already been rasterized. The rasterization stage 760 may generate fragment data (e.g., interpolated vertex attributes associated with a particular sample location for each covered pixel) that are transmitted to the fragment shading stage 770.

The fragment shading stage 770 may process fragment data by performing a set of operations (e.g., a fragment shader or a program) on each of the fragments. The fragment shading stage 770 may generate pixel data (e.g., color values) for the fragment such as by performing lighting operations or sampling texture maps using interpolated texture coordinates for the fragment. The fragment shading stage 770 may generate pixel data that is transmitted to the raster operations stage 780.

The raster operations stage 780 may perform various operations on the pixel data such as performing alpha tests, stencil tests, and blending the pixel data with other pixel data corresponding to other fragments associated with the pixel. When the raster operations stage 780 has finished processing the pixel data (e.g., the output data 702), the pixel data may be written to a render target such as a frame buffer, a color buffer, or the like.

It will be appreciated that one or more stages may additionally or alternatively be included in the graphics processing pipeline 700 in addition to or in lieu of one or more of the stages described above. Various implementations of the abstract graphics processing pipeline may implement different stages. Furthermore, one or more of the stages described above may be excluded from the graphics processing pipeline in some embodiments (such as the geometry shading stage 740). Other types of graphics processing pipelines are contemplated as being within the scope of the present disclosure. Furthermore, any of the stages of the graphics processing pipeline 700 may be implemented by one or more dedicated hardware units within a graphics processor such as PPU 400. Other stages of the graphics processing pipeline 700 may be implemented by programmable hardware units such as the SM 540 of the PPU 400.

The graphics processing pipeline 700 may be implemented via an application executed by a host processor, such as a CPU. In an embodiment, a device driver may implement an application programming interface (API) that defines various functions that can be utilized by an application in order to generate graphical data for display. The device driver may be a software program that includes a plurality of instructions that control the operation of the PPU 400. The API may provide an abstraction for a programmer that lets a programmer utilize specialized graphics hardware, such as the PPU 400, to generate the graphical data without requiring the programmer to utilize the specific instruction set for the PPU 400. The application may include an API call that is routed to the device driver for the PPU 400. The device driver may interpret the API call and perform various operations to respond to the API call. In some instances, the device driver may perform operations by executing instructions on the CPU. In some instances, the device driver may perform operations, at least in part, by launching operations on the PPU 400 utilizing an input/output interface between the CPU and the PPU 400. In an embodiment, the device driver is configured to implement the graphics processing pipeline 700 utilizing the hardware of the PPU 400.

Various programs may be executed within the PPU 400 in order to implement the various stages of the graphics processing pipeline 700. For example, the device driver may launch a kernel on the PPU 400 to perform the vertex shading stage 720 on one SM 540 (or multiple SMs 540). The device driver (or the initial kernel executed by the PPU 400) may launch other kernels on the PPU 400 to perform other stages of the graphics processing pipeline 700, such as the geometry shading stage 740 and the fragment shading stage 770. In some embodiments, some stages of the graphics processing pipeline 700 may be implemented on fixed unit hardware such as a rasterizer or a data assembler implemented within the PPU 400. It will be appreciated that results from one kernel may be processed by one or more intervening fixed function hardware units before being processed by a subsequent kernel on an SM 540.

### Machine Learning

Deep neural networks (DNNs) developed on processors, such as the PPU 400 have been used for diverse use cases, from self-driving cars to faster drug development, from automatic image captioning in online image databases to smart real-time language translation in video chat applications. Deep learning is a technique that models the neural learning process of the human brain, continually learning, continually getting smarter, and delivering more accurate results more quickly over time. A child is initially taught by an adult to correctly identify and classify various shapes, eventually being able to identify shapes without any coaching. Similarly, a deep learning or neural learning system may be trained in object recognition and classification to identify objects and classify those objects.

At the simplest level, neurons in the human brain look at various inputs that are received, importance levels are assigned to each of these inputs, and output is passed on to other neurons to act upon. An artificial neuron or perceptron is the most basic model of a neural network. In one example, a perceptron may receive one or more inputs that represent various features of an object that the perceptron is being trained to recognize and classify, and each of these features may be assigned a certain weight based on the importance of that feature in defining the shape of an object.

A deep neural network (DNN) model includes multiple layers of many connected nodes (e.g., perceptrons, Boltzmann machines, radial basis functions, convolutional layers, etc.) that can be trained with enormous amounts of input data to quickly solve complex problems with high accuracy. In one example, a first layer of the DNN model breaks down an input image of an automobile into various sections and looks for basic patterns such as lines and angles. The second layer may assemble the lines to look for higher level patterns such as wheels, windshields, and mirrors. The next layer may identify a type of vehicle, and the final few layers may generate a label for the input image, identifying the model of a specific automobile brand.

Once the DNN is trained, it may be deployed and used to identify and classify objects or patterns in a process known as inference. Examples of inference (the process through which a DNN extracts useful information from a given input) include identifying handwritten numbers on checks deposited into ATM machines, identifying images of friends in photos, delivering movie recommendations to over fifty million users, identifying and classifying different types of automobiles, pedestrians, and road hazards in driverless cars, or translating human speech in real-time.

During training, data flows through the DNN in a forward propagation phase until a prediction is produced that indicates a label corresponding to the input. If the neural network does not correctly label the input, then errors between the correct label and the predicted label may be analyzed, and the weights may be adjusted for each feature during a backward propagation phase until the DNN correctly labels the input and other inputs in a training dataset. Training complex neural networks requires massive amounts of parallel computing performance, including floating-point multiplications and additions that may be supported by the PPU 400.

Whether during training, testing, or inference, neural networks rely heavily on matrix math operations, and complex multi-layered networks require tremendous amounts of floating-point performance and bandwidth for both efficiency and speed. In some embodiments (e.g., with thousands of processing cores, optimized for matrix math operations, delivering tens to hundreds of TFLOPS of performance), the PPU 400 may be a computing platform capable of supporting deep neural network-based artificial intelligence and machine learning applications.

### Example Data Center

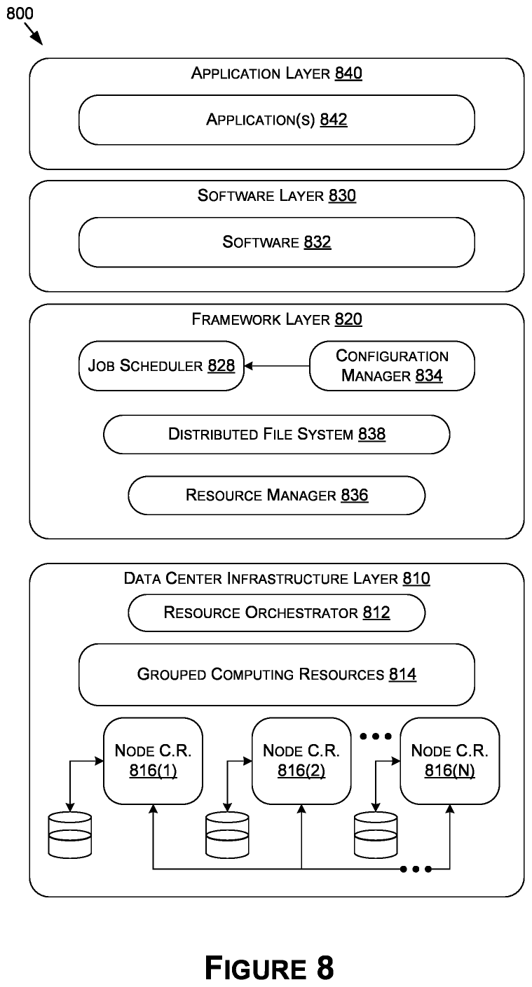

FIG. 8 illustrates an example data center 800 that may be used in at least one embodiments of the present disclosure. The data center 800 may include a data center infrastructure layer 810, a framework layer 820, a software layer 830, and/or an application layer 840.

As shown in FIG. 8, the data center infrastructure layer 810 may include a resource orchestrator 812, grouped computing resources 814, and node computing resources (“node C.R.s”) 816(1)-816(N), where “N” represents any whole, positive integer. In at least one embodiment, node C.R.s 816(1)-816(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 816(1)-816(N) may correspond to a server having one or more of the above-mentioned computing resources. In addition, in some embodiments, the node C.R.s 816(1)-8161(N) may include one or more virtual components, such as vGPUs, vCPUs, and/or the like, and/or one or more of the node C.R.s 816(1)-816(N) may correspond to a virtual machine (VM).

In at least one embodiment, grouped computing resources 814 may include separate groupings of node C.R.s 816 housed within one or more racks (not shown), or many racks housed in data centers at various geographical locations (also not shown). Separate groupings of node C.R.s 816 within grouped computing resources 814 may include grouped compute, network, memory or storage resources that may be configured or allocated to support one or more workloads. In at least one embodiment, several node C.R.s 816 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 812 may configure or otherwise control one or more node C.R.s 816(1)-816(N) and/or grouped computing resources 814. In at least one embodiment, resource orchestrator 812 may include a software design infrastructure (SDI) management entity for the data center 800. The resource orchestrator 812 may include hardware, software, or some combination thereof.

In at least one embodiment, as shown in FIG. 8, framework layer 820 may include a job scheduler 828, a configuration manager 834, a resource manager 836, and/or a distributed file system 838. The framework layer 820 may include a framework to support software 832 of software layer 830 and/or one or more application(s) 842 of application layer 840. The software 832 or application(s) 842 may respectively include web-based service software or applications, such as those provided by Amazon Web Services, Google Cloud and Microsoft Azure. The framework layer 820 may be, but is not limited to, a type of free and open-source software web application framework such as Apache Spark™ (hereinafter “Spark”) that may utilize distributed file system 838 for large-scale data processing (e.g., “big data”). In at least one embodiment, job scheduler 828 may include a Spark driver to facilitate scheduling of workloads supported by various layers of data center 800. The configuration manager 834 may be capable of configuring different layers such as software layer 830 and framework layer 820 including Spark and distributed file system 838 for supporting large-scale data processing. The resource manager 836 may be capable of managing clustered or grouped computing resources mapped to or allocated for support of distributed file system 838 and job scheduler 828. In at least one embodiment, clustered or grouped computing resources may include grouped computing resource 814 at data center infrastructure layer 810. The resource manager 836 may coordinate with resource orchestrator 812 to manage these mapped or allocated computing resources.

In at least one embodiment, software 832 included in software layer 830 may include software used by at least portions of node C.R.s 816(1)-816(N), grouped computing resources 814, and/or distributed file system 838 of framework layer 820. One or more types of software may include, but are not limited to, Internet web page search software, e-mail virus scan software, database software, and streaming video content software.

In at least one embodiment, application(s) 842 included in application layer 840 may include one or more types of applications used by at least portions of node C.R.s 816(1)-816(N), grouped computing resources 814, and/or distributed file system 838 of framework layer 820. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 834, resource manager 836, and resource orchestrator 812 may implement any number and type of self-modifying actions based on any amount and type of data acquired in any technically feasible fashion. Self-modifying actions may relieve a data center operator of data center 800 from making possibly bad configuration decisions and possibly avoiding underutilized and/or poor performing portions of a data center.

The data center 800 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described above with respect to the data center 800. In at least one embodiment, trained or deployed machine learning models corresponding to one or more neural networks may be used to infer or predict information using resources described above with respect to the data center 800 by using weight parameters calculated through one or more training techniques, such as but not limited to those described herein.

In at least one embodiment, the data center 800 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or performing inferencing of information, such as image recognition, speech recognition, or other artificial intelligence services.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of any known computing device(s). In addition, where backend devices (e.g., servers, NAS, etc.) are implemented, the backend devices may be included as part of a data center 800, an example of which is described in more detail herein with respect to FIG. 8.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may be implemented using any known computing device(s). By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

What is claimed is:

1. One or more parallel processors comprising one or more processing units to:
transcode, on general-purpose hardware of the one or more parallel processors, data into transcoded data in a supported compression format; and
decompress the transcoded data on dedicated hardware of the one or more parallel processors, the dedicated hardware being customized for decompression of the supported compression formats.

2. The one or more GPUs of claim 1, wherein the supported compression format is a sliding window dictionary-based compression format.

3. The one or more parallel processors of claim 1, wherein the one or more processing units are further to generate the data based at least on executing one or more entropy decoding operations on the general-purpose hardware of the one or more parallel processors.

4. The one or more parallel processors of claim 1, wherein the one or more processing units are further to decode a plurality of streams of compressed data from a block of literals in parallel using a common set of shared instructions on the general-purpose hardware of the one or more parallel processors.

5. The one or more parallel processors of claim 1, wherein the one or more processing units are further to decode a plurality of blocks of literals in parallel using a common set of shared instructions on the general-purpose hardware of the one or more parallel processors.

6. The one or more parallel processors of claim 1, wherein the one or more processing units are further to decode one or more blocks of dictionary references based at least on executing one or more operations common to extra bit decoding and asymmetric numeral system (ANS) decoding in parallel using a common set of shared instructions on the general-purpose hardware of the one or more parallel processors.

7. The one or more parallel processors of claim 1, wherein the one or more processing units are further to execute one or more independent reads associated with each of a plurality of blocks of at least one of literals or dictionary references in parallel using a common set of shared instructions on the general-purpose hardware of the one or more parallel processors.

8. The one or more GPUs of claim 1, wherein the one or more processing units are further to decode a plurality of blocks of dictionary references in parallel using a common set of shared instructions on the general-purpose hardware of the one or more parallel processors.

9. The one or more parallel processors of claim 1 wherein the one or more processing units are further to decode compressed data in Zstandard to generate the data and transcode the data to Snappy on the general-purpose hardware of the one or more parallel processors.

10. The one or more parallel processors of claim 1, wherein the one or more processing units are further to decompress the transcoded data in response to querying associated compressed data or loading the associated compressed data onto the one or more parallel processors.

11. The one or more parallel processors of claim 1, wherein the dedicated hardware of the one or more parallel processors is a copy engine of the one or more parallel processors.

12. The one or more parallel processors of claim 1, wherein the one or more parallel processors are comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system for performing remote operations;
a system for performing real-time streaming;
a system for generating or presenting one or more of augmented reality content, virtual reality content, or mixed reality content;
a system implemented using an edge device;
a system implemented using a robot;
a system for performing conversational AI operations;
a system implementing one or more language models;
a system implementing one or more large language models (LLMs);
a system for generating synthetic data;
a system for generating synthetic data using AI;
a system incorporating one or more virtual machines (VMs);
a system implemented at least partially in a data center; or
a system implemented at least partially using cloud computing resources.

13. A system comprising one or more processing units to decompress transcoded data using dedicated hardware of a graphics processing unit (GPU), the dedicated hardware being customized for decompression of a supported compression format.

14. The system of claim 13, wherein the one or more processing units are further to generate, on general-purpose hardware, the transcoded data in the supported compression format.

15. The system of claim 13, wherein the one or more processing units are further to generate the transcoded data based at least on executing one or more entropy decoding operations on general-purpose hardware of the GPU to generate decoded data and transcoding the decoded data on the general-purpose hardware of the GPU.

16. The system of claim 13, wherein the supported compression format is a sliding window dictionary-based compression format.

17. The system of claim 13, wherein the one or more processing units are further to decompress the transcoded data in response to at least one of querying associated compressed data or loading the associated compressed data onto the one or more GPUs.

18. The system of claim 13, wherein the system is comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system for performing remote operations;
a system for performing real-time streaming;
a system for generating or presenting one or more of augmented reality content, virtual reality content, or mixed reality content;
a system implemented using an edge device;
a system implemented using a robot;
a system for performing conversational AI operations;
a system implementing one or more language models;
a system implementing one or more large language models (LLMs);
a system for generating synthetic data;
a system for generating synthetic data using AI;
a system incorporating one or more virtual machines (VMs);
a system implemented at least partially in a data center; or
a system implemented at least partially using cloud computing resources.

19. A method comprising:
transcoding, on a parallel processor, data into transcoded data in a supported compression format; and
decompressing the transcoded data on fixed-function hardware of the parallel processor, the fixed-function hardware being customized for decompression of the supported compression format.

20. The method of claim 19, wherein the method is performed by at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system for performing remote operations;
a system for performing real-time streaming;
a system for generating or presenting one or more of augmented reality content, virtual reality content, or mixed reality content;
a system implemented using an edge device;
a system implemented using a robot;
a system for performing conversational AI operations;
a system implementing one or more language models;
a system implementing one or more large language models (LLMs);
a system for generating synthetic data;
a system for generating synthetic data using AI;
a system incorporating one or more virtual machines (VMs);
a system implemented at least partially in a data center; or
a system implemented at least partially using cloud computing resources.
